(19) United States
(12) Patent Application Publication
(10) Pub. No.: US 2020/0116515 A1
(43) Pub. Date: Apr. 16, 2020

(54) Autonomous Vehicle Capability and Operational Domain Evaluation and Selection for Improved Computational Resource Usage

(71) Applicant: UATC, LLC, San Francisco, CA (US)

(72) Inventors: Valerie Nina Chadha, San Francisco, CA (US); Ye Yuan, Belmont, CA (US); Andrew Raymond Sturges, San Francisco, CA (US); Neil Stegall, Pittsburgh, PA (US); Brent Justin Goldman, San Francisco, CA (US); Rei Chiang, San Francisco, CA (US); Arvind Srinivasan, Menlo Park, CA (US); Yifan Liu, Dublin, CA (US)

(21) Appl. No.: 16/601,013

(22) Filed: Oct. 14, 2019

Related U.S. Application Data
(60) Provisional application No. 62/746,298, filed on Oct. 16, 2018.

(51) Int. Cl. G01C 21/34; G01C 21/36; G05D 1/00

(52) U.S. Cl. CPC G01C 21/3461; G01C 21/3484; G05D 2201/0213; G05D 1/0088; G05D 1/0055; G01C 21/3691

(57) ABSTRACT

Systems and methods for determining autonomous vehicle operational domains improve vehicle data usage are provided. In one example embodiment, a computing system can obtain data indicative of a capability of an autonomous vehicle. The computing system can identify one or more a plurality of operational domains. The computing system can determine, for each of the operational domain(s), a respective level of addressability associated with the respective operational domain based at least in part on the capability of the autonomous vehicle. The computing system can provide an output based at least in part on the levels of addressability associated with the operational domain(s).

### RELATED APPLICATION

This application claims priority to and the benefit of U.S. Provisional Patent Application No. 62/746,298, titled “AUTONOMOUS VEHICLE CAPABILITY AND OPERATIONAL DOMAIN EVALUATION AND SELECTION FOR IMPROVED COMPUTATIONAL RESOURCE USAGE,” and filed on Oct. 16, 2018. U.S. Provisional Patent Application No. 62/746,298 is hereby incorporated by reference herein in its entirety.

### FIELD

The present disclosure relates generally to evaluating the capabilities of an autonomous vehicle as well as the operational domains in which the autonomous vehicle may operate to increase the efficiency of autonomous vehicle operation.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for determining autonomous vehicle operational domains. The method includes obtaining, by a computing system including one or more computing devices, data indicative of one or more capabilities. The method includes obtaining, by the computing system, data associated with a plurality of potential travel routes within an operational domain of the autonomous vehicle. The method includes determining, by the computing system, a level of addressability of the operational domain based at least in part on the one or more capabilities of the autonomous vehicle and the plurality of potential travel routes within the operational domain. The method includes providing, by the computing system, an output associated with the operational domain based at least in part on the level of addressability associated with the operational domain.

Another example aspect of the present disclosure is directed to a computing system. The computing system includes one or more processors and one or more tangible, non-transitory, computer readable media that collectively store instructions that when executed by the one or more processors cause the computing system to perform operations. The operations include obtaining data indicative of one or more capabilities of an autonomous vehicle. The operations include identifying one or more operational domains. The operations include for each of the one or more operational domains, obtaining data associated with a plurality of potential travel routes within the respective operational domain. The operations include determining, for each respective operational domain, a respective level of addressability based at least in part on the one or more capabilities of the autonomous vehicle and the plurality of potential travel routes within the respective operational domain. The operations include providing an output based at least in part on one or more of the respective levels of addressability associated with the one or more operational domains.

Yet another example aspect of the present disclosure is directed to one or more tangible, non-transitory, computer-readable media that collectively store instructions that, when executed by one or more processors, cause the one or more processors to perform operations. The operations include obtaining data indicative of a capability of an autonomous vehicle. The operations include identifying a plurality of operational domains. The operations include determining, for each of the operational domains, a respective level of addressability associated with the respective operational domain based at least in part on the capability of the autonomous vehicle. The operations include providing an output associated with the plurality of operational domains based at least in part on the levels of addressability associated with the plurality of operational domains.

Other example aspects of the present disclosure are directed to systems, methods, vehicles, apparatuses, tangible, non-transitory computer-readable media, and memory devices for controlling autonomous vehicles and efficiently using the computational resources of the autonomous vehicles.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example autonomous vehicle computing system according to example embodiments of the present disclosure;

FIG. 2 depicts an example operations computing system of a service entity according to example embodiments of the present disclosure;

FIG. 3 depicts an example computing system for evaluating operational domains according to example embodiments of the present disclosure;

FIGS. 4A-C depict example data structures including capabilities of an autonomous vehicle according to example embodiments of the present disclosure;

FIGS. 5A-D depict an example operational domain according to example embodiments of the present disclosure;

FIGS. 6A-B depict another example operational domain according to example embodiments of the present disclosure;

FIG. 7 depicts an example output including a ranking of operational domains according to example embodiments of the present disclosure;

FIG. 8 depicts an example method for determining autonomous vehicle operational domains according to example embodiments of the present disclosure;

FIG. 9 depicts example system with units for performing operations and functions according to example embodiments of the present disclosure; and

FIG. 10 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved techniques for evaluating the capabilities of an autonomous vehicle as well as the operational domains in which the autonomous vehicle may operate for improving utilization of the vehicle's data and processing resources. For instance, an autonomous vehicle can be utilized to perform vehicle services (e.g., user transportation services, etc.). The vehicle services can be offered to users by a service entity (e.g., a company that offers and coordinates the provision of vehicle services). The service entity can select various operational domains (e.g., geographic areas) in which the autonomous vehicle is to provide the vehicle services. In the event that a user requests a vehicle service (e.g., via a service request), a computing system of the service entity can send a vehicle service assignment to an autonomous vehicle that is online with the service entity. When it is not addressing a vehicle service assignment/performing a vehicle service, an autonomous vehicle can be in an idle state. However, even in the idle state, an autonomous vehicle can continue to acquire sensor data to remain cognizant of its environment (e.g., whether the vehicle is parked, moving, etc.). This can cause the autonomous vehicle to waste its processing, data storage, and power resources while it is not performing a vehicle service.

The systems and methods of the present disclosure help to reduce such non-essential computational usage by providing an improved approach to evaluating operational domains based on the capabilities of the autonomous vehicle. To do so, a computing system can determine a level of addressability for an operational domain given a capability of the autonomous vehicle. A level of addressability can be indicative of the ability of the autonomous vehicle to operate within an operational domain. For instance, the level of addressability can be indicative of the level of utilization (e.g., for performing vehicle services) that an autonomous vehicle may experience in an operational domain (e.g., the higher the level of addressability—the high potential utilization). The level of addressability can be expressed as an integer, a percentage, a fraction, a rate, and/or another type of classification (e.g., low, moderate, high, etc.) that may reflect the how many routes an autonomous vehicle can traverse in the operational domain, how much/often the autonomous vehicle may be utilized in the operational domain (e.g., for performing vehicle services), etc.

By way of example, a computing system can obtain data indicative of various capabilities of the autonomous vehicle. This can include, for example, capabilities that are currently being and/or planned to be developed (e.g., the ability to make an unprotected left turn, the ability to operate in heavy snowfall, etc.). The computing system can also obtain data indicative of the potential travel routes within the operational domain (e.g., various travel routes for transporting users). The computing system can determine how many of these potential routes could be traversed by an autonomous vehicle given a capability. For example, the computing system can determine how many of these routes could be traversed by an autonomous vehicle if the autonomous vehicle was capable of performing an unprotected left turn. The computing system can determine a level of addressability for the operational domain based on the number of traversable routes (e.g., indicating the accessibility of that operational domain to the autonomous vehicle). Ultimately, the computing system can initiate a variety of actions based on the level of addressability such as, for example, ranking operational domains, prioritizing vehicle technology development, providing mapping instructions, performing geo-fencing, etc. In this way, the systems and methods described herein provide a more computationally efficient approach for evaluating and selecting operational domain(s) (and capabilities) of autonomous vehicles that will lead to higher autonomous vehicle usage, thereby reducing potential computational waste.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

An autonomous vehicle can perform vehicle services for one or more service entities. A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of vehicle service(s) to one or more users. For example, a service entity can offer vehicle service(s) to users via a software application (e.g., on a user computing device, etc.), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

An autonomous vehicle can operate within an operational domain, for example, to provide the vehicle services. An operational domain can be an environment in which an autonomous vehicle has, is, or may potentially operate. For example, an operational domain can include a geographic area. The geographic area can be a market in which vehicles associated with the service entity (e.g., non-autonomous vehicles, autonomous vehicles, etc.) currently operate or a potential market in which vehicles associated with the service entity may potentially operate in the future. An operational domain may include a city, town, other municipality, etc. In some implementations, an operational domain can include one or more sub-regions. For example, the operational domain can include a city with one or more neighborhoods. Moreover, the operational domain can include travel ways (e.g., roads, streets, pathways, intersections, etc.). The travel ways can include lanes and/or other designated portions for a vehicle to travel on the travel ways.

A computing system (e.g., associated with a service entity) can evaluate various operational domains to determine which would be most appropriate for the operation of autonomous vehicles. The computing system can be configured to identify one or more operational domains of interest. The identified operational domain(s) can include, for example, geographic areas in which a service entity may consider utilizing autonomous vehicles to provide vehicle services. For instance, this may include a city in which transportation services are currently provided by non-autonomous vehicles, but not autonomous vehicles. In some implementations, identified operational domain(s) can include geographic area(s) in which a service entity does not utilize any vehicles (non-autonomous or autonomous) to provide vehicle services. This can include, for example, markets that are being serviced by other service entities. In some implementations, the identified operational domain(s) can include geographic area(s) in which a service entity previously and/or currently utilizes autonomous vehicles to provide vehicle services, but aims to conduct further analysis of the geographic area. In some implementations, the identified operational domain(s) can include geographic area(s) in which a service entity previously and/or currently utilizes both non-autonomous and autonomous vehicles to provide vehicle services.

To help evaluate an operational domain, the computing system can obtain data associated with a plurality of potential travel routes within the operational domain. Such data can be obtained via a local memory and/or a remote memory that stores travel route data associated with the operational domain. Each of the plurality of potential travel routes can start and end within the operational domain. For instance, in some implementations, the plurality of travel routes can be based at least in part on the travel routes within the operational domain that can be traversed by non-autonomous, human-driven vehicles.

In some implementations, the plurality of travel routes can be based on historical travel route data. For example, the computing system can obtain data indicative of the travel routes previously traversed by non-autonomous vehicles when providing vehicle services within the operational domain (e.g., when transporting users from one location to another). These historically travelled routes can provide real-world examples of the types of routes that may need to be utilized by autonomous vehicles to provide vehicle services within the operational domain. In some implementations, the historic travel route data can be constrained to a particular time period (e.g., within the past 6 months, 12 months, 24 months, etc.).

Additionally, or alternatively, the plurality of travel routes can be based at least in part on simulated travel route data. For example, a simulation can be run to generate a number of simulated travel routes in an operational domain given a variety of vehicle service requests. This can allow an operational domain to be evaluated without real-world travel route data associated therewith (e.g., for prospective markets with little or no vehicle presence). In some implementations, the plurality of travel routes can be based at least in part on predicted travel route data. For example, the plurality of travel routes for one operational domain can be predicted based on the real-world and/or simulated travelled routes extrapolated from another operational domain (e.g., with like circumstances, travel ways, infrastructure, etc.).

Additionally, or alternatively, to help evaluate an operational domain, the computing system can obtain other information associated with the operational domain (other than the plurality of travel routes). For instance, the computing system can obtain information indicative the weather associated with an operational domain. Such information can indicate where, how often, and how much snow, rain, sleet, and/or other weather conditions are experienced by the operational domain. Additionally, or alternatively, the computing system can obtain information indicative of a regulation or policy associated with an operational domain. For example, a city may have regulations that restrict autonomous vehicles from operating in certain portions of the city. Additionally, or alternatively, the computing system can obtain information indicative of the light conditions associated with the operational domain (e.g., frequency and brightness of street lighting, sun exposure, tree coverage, etc.). Additionally, or alternatively, the computing system can obtain object data associated with the operational domain. The object data can be indicative of the types, numbers, trends, etc. of the objects within the operational domain. For example, the object data can indicate whether a particular operational domain (e.g., city) has a high number of trees, pedestrians, bicyclists, etc.

The operational domain(s) can be evaluated based at least in part on one or more vehicle capabilities. A capability can be indicative of an ability of an autonomous vehicle such as, for example, an ability that helps the vehicle autonomously operate (e.g., with little or no operator input). For instance, the capabilities can be indicative of the vehicle's ability to operate (e.g., perceive its surroundings, predict object motion, plan vehicle motion, etc.) in certain weather condition(s) (e.g., rain, snow, sleet, etc.). Additionally or alternatively, the capabilities can be indicative of vehicle operating condition(s) (e.g., a vehicle's max speed, horizontal field of view, etc.). Additionally, or alternatively, the capabilities can be indicative of a vehicle maneuverability (e.g., vehicle can handle unprotected left turns, U-turns, four-way intersections, etc.). The computing system can obtain data indicative of one or more capabilities of an autonomous vehicle from a local and/or remote memory that stores such data.

The computing system can determine a level of addressability associated with an operational domain based at least in part on the one or more capabilities of the autonomous vehicle and the plurality of potential travel routes within the operational domain of the autonomous vehicle. In some implementations, the level of addressability can be determined based at least in part on the additional information associated with the operational domain (e.g., weather data, regulation/policy data, lighting conditions, object data, etc.). The level of addressability can be indicative of the ability of the autonomous vehicle to operate within the operational domain. Moreover, the level of addressability can be indicative of the level of usage that an autonomous vehicle may experience in an operational domain (e.g., for performing vehicle services).

To determine the level of addressability of an operational domain, the computing system can determine the number of the potential travel routes that are traversable by the autonomous vehicle within the operational domain based at least in part on the one or more capabilities of the autonomous vehicle. The computing system can be configured to filter the plurality of potential travel routes within the operational domain based at least in part on a capability of the autonomous vehicle. For example, the computing system can obtain data indicative of a plurality of potential travel routes within a first operational domain (e.g., City A). The potential travel routes can be based on the real-world travel routes of City A that have been traversed by non-autonomous vehicles while providing vehicle services (e.g., transporting users) within the last twelve months. The computing system can determine how many of these potential travel routes would be traversable by an autonomous vehicle if the vehicle had one or more capabilities (e.g., the ability to make an unprotected left turn, make a U-turn, etc.) and/or how many of these potential travel routes would not be traversable by an autonomous vehicle if the vehicle did not have the particular capability (e.g., did not have the ability to make an unprotected left turn, U-turn, etc.). Additionally, or alternatively, the computing system can filter the plurality of potential travel routes based at least in part on other information associated with the geographic area. For example, in the event that current travel routes go through areas that prohibit autonomous vehicle operation, those potential travel routes would be identified as not traversable by the autonomous vehicle.

The level of addressability can be calculated based on various factor(s). In some implementations, the level of addressability can be measured by the number of potential travel routes that are determined to be traversable by the autonomous vehicle (e.g., the higher number of potential travel routes—the higher the level of addressability). The number of potential travel routes can be represented as an integer, a percentage (e.g., 50%), a fraction (e.g., 50 out of 100 routes), and/or another type of classification (e.g., low, moderate, high, etc.). In some implementations, the level of addressability can be measured based on a travel distance associated with the number of the potential travel routes that are traversable by the autonomous vehicle (e.g., an aggregate number of miles, kilometers, etc. of the potential travel routes that are traversable by the autonomous vehicle). This distance can represent a potential amount of distance that would be travelled by an autonomous vehicle while performing vehicle services. In such as case, the level of addressability can be higher for a greater distance (e.g., reflecting a reduced amount of potential idle time). The travel distance can be represented as an integer (e.g., 75 miles, etc.), a percentage (75% of the possible mileage, etc.), a fraction (e.g., 75/100 miles, etc.), and/or another type of classification (e.g., low, moderate, high, etc.).

In some implementations, the level of addressability can be based at least in part on a service time associated with the potential travel routes that are traversable by the autonomous vehicle. For example, the computing system can determine an aggregate amount of time that an autonomous vehicle would be travelling along the travel routes (e.g., when addressing service requests). A greater amount of time can be indicative of a greater usage rate (and less idle time). In such an example, the longer the amount of service time, the higher the level of addressability. The time can be represented as an integer, a percentage, a fraction, and/or another type of classification (e.g., low, moderate, high, etc.).

In some implementations, the level of addressability can be based at least in part on a number of predicted service requests associated with the potential travel routes that are traversable by the autonomous vehicle. For example, as described herein the potential travel routes can be associated with real-world travel routes that were traversed by non-autonomous vehicles while performing a vehicle service in accordance with a user's service request (e.g., transporting a user to a requested destination). Each of potential travel routes can be associated with a projected number of service requests that is based at least in part on an associated number of real-world service requests. A higher number of predicted service requests can be indicative of a higher potential usage rate (and lower idle time) of the autonomous vehicle. Accordingly, the operational domain can be afforded a higher level of addressability for a greater number of predicted service requests. Additionally, or alternatively, the level of addressability can be based at least in part on a level of predicted revenue associated with the potential travel routes that are traversable by the autonomous vehicle. The level of revenue can be calculated based on the projected service requests associated with the potential travel routes. The number of service requests and/or revenue can be represented as an integer, a percentage, a fraction, and/or another type of classification (e.g., low, moderate, high, etc.).

In some implementations, the level of addressability can be based on a comparison of how a vehicle service would be performed by a non-autonomous vehicle versus how the vehicle service would be performed by an autonomous vehicle. For example, the computing system can obtain data that indicates a pick-up location, travel route, destination location, and travel time associated with a first vehicle service that transports a user from one location to another within an operational domain via a non-autonomous vehicle. This data can be based at least in part on real-world data. A simulation can be run to determine these parameters in the event that an autonomous vehicle is used to transport the user for the first vehicle service. The computing system can compare this information to see whether an autonomous vehicle would perform the vehicle service as well as the non-autonomous vehicle. For example, in the event that the service time is substantially similar (e.g., within 30 seconds, 1 minute, etc.) and the non-autonomous vehicle is able to get similarly close to the pick-up and destination locations (e.g., within 10 m, 20 m, etc.), the level of addressability can be increased. However, in the event that the autonomous vehicle would take significantly longer to complete the vehicle service and/or be unable to arrive proximate to the pick-up and/or destination locations, the level of addressability can be decreased.

The computing system can evaluate multiple capabilities across an operational domain to determine which capabilities would have the greatest effect on the level of addressability for that operational domain. For instance, the computing system can obtain data indicative of a first capability (e.g., the ability to operate in heavy snow) and a second capability (e.g., the ability to perform an unprotected left turn). The computing system can determine the level of addressability for a first operational domain (e.g., City A) for each capability. For example, the computing system can determine a first level of addressability for the first operational domain (e.g., City A) based at least in part on the first capability (e.g., the ability to operate in heavy snow) and a second level of addressability for the first operational domain (e.g., City A) based at least in part on the second capability (e.g., the ability to perform an unprotected left turn). This can allow the computing system to determine what the level of addressability would be for City A if the autonomous vehicle was able to operate in heavy snow and/or if the autonomous vehicle was able to perform an unprotected left turn. Moreover, the computing system can compare the first level of addressability and the second level of addressability to help determine which capability would lead to higher vehicle usage in the first operational domain. By way of example, the second capability (e.g., the ability to perform an unprotected left turn) may lead to a higher level of addressability for City A than the first capability (e.g., the ability to operate in heavy snow) in the event that the second capability would allow for a greater number of potential travel routes, travel distance, projected service requests, service time, projected revenue, etc. in City A. The computing system can continue this analysis by iterating over additional capabilities and/or operational domains. Ultimately, as further described herein, this can allow the computing system to recommend that the development of one of the capabilities (e.g., the ability to perform unprotected left turns) be prioritized over the development of another (e.g., the ability to operate in heavy snow).

Additionally or alternatively, the computing system can iterate its analysis across multiple operational domains given one or more capabilities. This can allow the computing system to compare the different levels of addressability across the various operational domains to help determine which operational domains may lead to higher autonomous vehicle utilization (and less idle time). For instance, the computing system can identify a first operational domain (e.g., City A) and a second operational domain (e.g., City B). The computing system can determine a first level of addressability for the first operational domain (e.g., City A) based at least in part on the one or more capabilities of the autonomous vehicle (e.g., ability to operate in heavy snow, ability to perform an unprotected left turn, etc.). This can include filtering a plurality of potential travel routes within the first operational domain (e.g., City A) based at least in part on the capabilities and/or other information (e.g., regulations/policies, etc.). The computing system can determine a second level of addressability for the second operational domain (e.g., City B) based at least in part on the one or more capabilities of the autonomous vehicle (e.g., ability to operate in heavy snow, ability to perform an unprotected left turn, etc.). This can include filtering a plurality of potential travel routes within the second operational domain (e.g., City B) based at least in part on the capabilities and/or other information (e.g., regulations/policies, etc.). The computing system can compare the levels of addressability of the two different operational domains to determine which has a higher likelihood of decreasing autonomous vehicle idle time. For example, in the event that the first level of addressability for City A is higher than the second level of addressability for City B, then the computing system can determine that City A would be a more appropriate operational domain for an autonomous vehicle. Ultimately, as further described herein, this can allow the computing system to prioritize different operational domains.

In some implementations, the computing system can evaluate operational domain(s) on a more granular level. For instance, as described herein, an operational domain can include one or more sub-regions (e.g., neighborhoods). The computing system can be configured to perform a similar type of analysis (as described herein) on the sub-region(s) of the operational domain to determine a level of addressability for each of the sub-region(s). By way of example, an operational domain (e.g., City A) can include a first sub-region (e.g., Neighborhood X) and a second sub-region (e.g., Neighborhood Y). For each sub-region, the computing system can determine a level of addressability in a similar manner as that described herein (e.g., based on the potential travel routes within that sub-region and one or more capabilities of the autonomous vehicle). The computing system can determine which sub-regions may lead to higher vehicle usage rates (and less idle time) based on the respective levels of addressability. Ultimately, as further described herein, this can help determine the boundaries within which an autonomous vehicle can operate in an operational domain and/or suggested retrieval and drop-off locations.

Additionally, or alternatively, the computing system can be configured to evaluate the individual travels ways (e.g., the associated lanes) and potential travel routes within a sub-region to determine which may be the most appropriate for autonomous vehicle operation. As described herein, a sub-region (e.g., a neighborhood, etc.) can include a plurality of travel ways (e.g., roads, etc.) and the travel ways can include lanes and/or other designated portions for traversing the travel ways. The computing system can obtain data indicative of a plurality of potential travel routes that utilize the travel ways within that sub-region. The computing system can evaluate these travel routes to determine which travel ways, lanes, other designated portions, etc. would be most appropriate for autonomous vehicle operation. By way of example, the computing system can determine a level of addressability of a particular travel way, lane, other designated portion, etc. based at least in part on the density of projected service requests associated therewith (e.g., based on historical/simulated/predicted service requests that would involve using that travel way, etc.), restrictions/policies associated therewith (e.g., whether a particular lane allows for autonomous vehicles, is under construction, etc.), estimated travel time, etc. Ultimately, this can allow the computing system to formulate a recommendation as to which potential travel routes within an operational domain would be most efficient for an autonomous vehicle.

The computing system can provide an output based at least in part on the level of addressability associated with the operational domain(s). In some implementations, the computing system can output data indicative of the level(s) of addressability for operational domain(s). For example, this can include a report that indicates the level(s) of addressability for an operational domain based at least in part on one or more capabilities. The report can additionally, or alternatively, be indicative of a variety of parameters associated with the operational domain including, for example: a projected number of total service assignments to be undertaken by an autonomous vehicle, a gross number of service requests/assignments, projected service distance, projected service time, revenue/profit data, etc. Such projections can be based at least in part on historic data associated with the operational domain (e.g., data associated with vehicle services provided via non-autonomous vehicles, etc.).

In some implementations, the computing system can determine a prioritization of at least one capability based at least in part on the level of addressability of the operational domain and output data indicative of the prioritization of the at least one capability. For example, in the event that it is determined that adding the ability to perform an unprotected left turn to an autonomous vehicle would lead to the highest level of addressability, the computing system can provide data (e.g., to another computing system, displayed on a display screen, etc.) indicating that the development of the unprotected left turn capability should be prioritized during vehicle technology development.

In some implementations, the computing system can be configured to rank a plurality of operational domains. For instance, the computing system can determine a ranking of at least a first operational domain (e.g., City A) and a second operational domain (e.g., City B) based at least in part on a first level of addressability (e.g., for City A) and a second level of addressability (e.g., for City B). The computing system can output data indicative of the ranking of at least the first operational domain and the second operational domain. This can allow for the prioritization of various operational domains based at least in part on their levels of addressability of autonomous vehicle operations.

In some implementations, the computing system can be configured to communicate a mapping instruction associated with an operational domain. For example, the computing system can determine that a first operational domain (e.g., City A) has a high level of addressability for autonomous vehicles. The computing system can determine whether autonomous vehicle map data (e.g., map data for vehicle autonomy system operations) exists for the first operational domain. In the event that the autonomous vehicle map data does not exist or is insufficient for autonomous vehicle operation in the first operational domain, the computing system can communicate (e.g., to another computing system) a mapping instruction indicating that further mapping of the operational domain is needed and/or recommended.

In some implementations, the computing system can be configured to communicate a geo-fencing instruction for an operational domain. For instance, as described herein, the computing system can determine that a particular sub-region (e.g., Neighborhood X) may have a higher level of addressability than other sub-regions of the operational domain. Accordingly, the computing system can determine one or more boundaries of that particular sub-region (e.g., defining boundaries around Neighborhood X within which an autonomous vehicle should operate) and output data indicative of the one or more boundaries. Additionally, or alternatively, the computing system can be configured to recommend particular travel way(s), lane(s), other designated portion(s), etc. for an autonomous vehicle to utilize within an operational domain. In this way, the computing system can indicate which sub-regions and travel ways would be most efficient for autonomous vehicle operation within an operational domain.

The systems and methods described herein provide a number of technical effects and benefits. More particularly, the systems and methods of the present disclosure provide improved techniques for evaluating an operational domain of an autonomous vehicle as well as the capabilities being developed for autonomous vehicles. For instance, as described herein, a computing system can determine which operational domains are the most appropriate for autonomous vehicle operation based on a level of addressability. The level of addressability can be an indicator of how much an autonomous vehicle would be used for providing vehicle services within an operational domain. By improving the ability to identify operational domains of potentially higher usage, the systems and methods can identify operational domains in which an autonomous vehicle would have less idle time. As described herein, idle time can lead to non-essential usage of onboard computational resources and more frequent maintenance (e.g., for download downlink, charging, etc.). Operational domains with higher autonomous vehicle usage rates lead to more productive utilization of the autonomous vehicle and its computational resources, while decreasing wasteful data usage.

Moreover, the systems and methods of the present disclosure provide improved techniques for prioritizing the development of vehicle capabilities. By prioritizing the development of certain capabilities over others, autonomous vehicles can more fully operate within the operational domains of higher usage, again leading to less idle time. Ultimately, by identifying more appropriate operational domains and important vehicle capabilities, the systems and methods of the present disclosure allow for more efficient utilization of an autonomous vehicle and its onboard computing system.

Example aspects of the present disclosure can provide an improvement to vehicle computing technology, such as autonomous vehicle computing technology. For instance, the systems and methods of the present disclosure provide an improved approach to evaluate operational domains of an autonomous vehicle so that the computational resources of the autonomous vehicle are more productively utilized. For example, a computing system (e.g., a computing system that is remote from the autonomous vehicle) can obtain data indicative of one or more capabilities of an autonomous vehicle and data associated with a plurality of potential travel routes within an operational domain of the autonomous vehicle. The computing system can determine a level of addressability associated with the operational domain based at least in part on the one or more capabilities of the autonomous vehicle and the plurality of potential travel routes within the operational domain of the autonomous vehicle. The level of addressability can be indicative of the utilization (potential utilization) of the autonomous vehicle within the operational domain. The computing system can initiate an action associated with the operational domain based at least in part on the level of addressability of the operational domain. The action can include, for example, operational domain selection, ranking, recommending, etc. as well as technology development prioritization. This process can be iterated for a plurality of capabilities and/or a plurality of operational domains. Accordingly, the computing system can determine which operational domains would lead to higher usage rates of autonomous vehicles (e.g., based on the level of addressability) and lower potential vehicle idle time. Moreover, the computing system can determine which capabilities may help increase vehicle productivity within an operational domain (e.g., based on the level of addressability) and, thus, should be prioritized for technology development. Accordingly, the computing system can identify operational domains and vehicle capabilities that would lead the autonomous vehicle(s) to more likely be utilized in a productive manner to benefit the autonomous vehicle (e.g., by increasing the likelihood that the autonomous vehicle will receive vehicle service assignments and avoiding idle data usage). This allows for a more efficient use of the processing, memory, and power resources of the vehicle's computing system, and reduces the need for autonomous vehicles to go offline to preserve such resources. Ultimately, the computing system can decrease wasteful usage of the computational resources of an idle autonomous vehicle by strategically analyzing and determining which operational domains (and vehicle capabilities) will lead to efficient autonomous vehicle operation, as described herein.

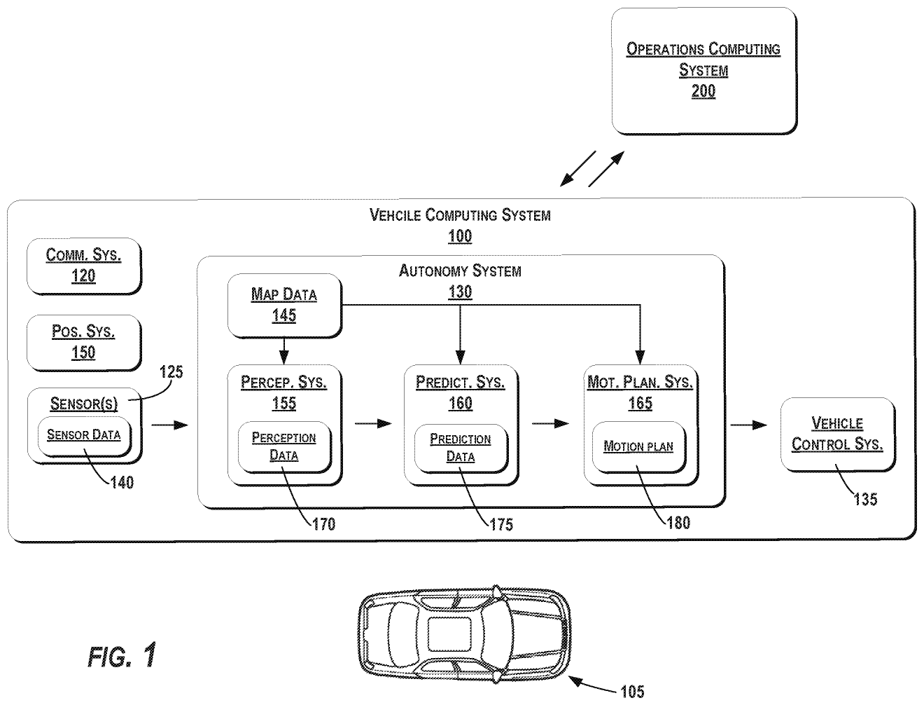

With reference now to the FIGS., example embodiments of the present disclosure will be discussed in further detail. FIG. 1 illustrates an example vehicle computing system 100 according to example embodiments of the present disclosure. The vehicle computing system 100 can be associated with an autonomous vehicle 105. The vehicle computing system 100 can be located onboard (e.g., included on and/or within) the autonomous vehicle 105.

The autonomous vehicle 105 incorporating the vehicle computing system 100 can be various types of vehicles. For instance, the autonomous vehicle 105 can be a ground-based autonomous vehicle such as an autonomous car, autonomous truck, autonomous bus, etc. The autonomous vehicle 105 can be an air-based autonomous vehicle (e.g., airplane, helicopter, or other aircraft) or other types of vehicles (e.g., watercraft, etc.). The autonomous vehicle 105 can drive, navigate, operate, etc. with minimal and/or no interaction from a human operator (e.g., driver). In some implementations, a human operator can be omitted from the autonomous vehicle 105 (and/or also omitted from remote control of the autonomous vehicle 105). In some implementations, a human operator can be included in the autonomous vehicle 105.

In some implementations, the autonomous vehicle 105 can be configured to operate in a plurality of operating modes. The autonomous vehicle 105 can be configured to operate in a fully autonomous (e.g., self-driving) operating mode in which the autonomous vehicle 105 is controllable without user input (e.g., can drive and navigate with no input from a human operator present in the autonomous vehicle 105 and/or remote from the autonomous vehicle 105). The autonomous vehicle 105 can operate in a semi-autonomous operating mode in which the autonomous vehicle 105 can operate with some input from a human operator present in the autonomous vehicle 105 (and/or a human operator that is remote from the autonomous vehicle 105). The autonomous vehicle 105 can enter into a manual operating mode in which the autonomous vehicle 105 is fully controllable by a human operator (e.g., human driver, pilot, etc.) and can be prohibited and/or disabled (e.g., temporary, permanently, etc.) from performing autonomous navigation (e.g., autonomous driving). In some implementations, the autonomous vehicle 105 can implement vehicle operating assistance technology (e.g., collision mitigation system, power assist steering, etc.) while in the manual operating mode to help assist the human operator of the autonomous vehicle 105.

The operating modes of the autonomous vehicle 105 can be stored in a memory onboard the autonomous vehicle 105. For example, the operating modes can be defined by an operating mode data structure (e.g., rule, list, table, etc.) that indicates one or more operating parameters for the autonomous vehicle 105, while in the particular operating mode. For example, an operating mode data structure can indicate that the autonomous vehicle 105 is to autonomously plan its motion when in the fully autonomous operating mode. The vehicle computing system 100 can access the memory when implementing an operating mode.

The operating mode of the autonomous vehicle 105 can be adjusted in a variety of manners. For example, the operating mode of the autonomous vehicle 105 can be selected remotely, off-board the autonomous vehicle 105. For example, a remote computing system (e.g., of a vehicle provider and/or service entity associated with the autonomous vehicle 105) can communicate data to the autonomous vehicle 105 instructing the autonomous vehicle 105 to enter into, exit from, maintain, etc. an operating mode. By way of example, such data can instruct the autonomous vehicle 105 to enter into the fully autonomous operating mode. In some implementations, the operating mode of the autonomous vehicle 105 can be set onboard and/or near the autonomous vehicle 105. For example, the vehicle computing system 100 can automatically determine when and where the autonomous vehicle 105 is to enter, change, maintain, etc. a particular operating mode (e.g., without user input). Additionally, or alternatively, the operating mode of the autonomous vehicle 105 can be manually selected via one or more interfaces located onboard the autonomous vehicle 105 (e.g., key switch, button, etc.) and/or associated with a computing device proximate to the autonomous vehicle 105 (e.g., a tablet operated by authorized personnel located near the autonomous vehicle 105). In some implementations, the operating mode of the autonomous vehicle 105 can be adjusted by manipulating a series of interfaces in a particular order to cause the autonomous vehicle 105 to enter into a particular operating mode.

The vehicle computing system 100 can include one or more computing devices located onboard the autonomous vehicle 105. For example, the computing device(s) can be located on and/or within the autonomous vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous vehicle 105 (e.g., its computing system, one or more processors, etc.) to perform operations and functions, such as those described herein for controlling an autonomous vehicle, activating an autonomous vehicle, recognizing that an autonomous vehicle is idle, implementing a task, de-activating an autonomous vehicle, etc.

The autonomous vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the autonomous vehicle 105 over one or more networks (e.g., via one or more wireless signal connections). For example, the communications system 120 can allow the autonomous vehicle to communicate and obtain data from an operations computing system 200 of a service entity. In some implementations, the communications system 120 can allow communication among one or more of the system(s) on-board the autonomous vehicle 105. The communications system 120 can include any suitable components for interfacing with one or more network(s), including, for example, transmitters, receivers, ports, controllers, antennas, and/or other suitable components that can help facilitate communication.

As shown in FIG. 1, the autonomous vehicle 105 can include one or more vehicle sensors 125, an autonomy computing system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 125 can be configured to acquire sensor data 140. This can include sensor data associated with the surrounding environment of the autonomous vehicle 105. For instance, the sensor data 140 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 140 can include image data, radar data, LIDAR data, and/or other data acquired by the vehicle sensor(s) 125. The autonomous vehicle 105 can also include other sensors configured to acquire data associated with the autonomous vehicle 105. For example, the autonomous vehicle 105 can include inertial measurement unit(s) and/or other sensors.

In some implementations, the sensor data 140 can be indicative of one or more objects within the surrounding environment of the autonomous vehicle 105. The object(s) can include, for example, vehicles, pedestrians, bicycles, and/or other objects. The object(s) can be located in front of, to the rear of, to the side of the autonomous vehicle 105, etc. The sensor data 140 can be indicative of locations associated with the object(s) within the surrounding environment of the autonomous vehicle 105 at one or more times. The vehicle sensor(s) 125 can provide the sensor data 140 to the autonomy computing system 130.

In addition to the sensor data 140, the autonomy computing system 130 can retrieve or otherwise obtain map data 145. The map data 145 can provide information about the surrounding environment of the autonomous vehicle 105. In some implementations, an autonomous vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the autonomous vehicle 105 in comprehending and perceiving its surrounding environment and its relationship thereto. In some implementations, the vehicle computing system 100 can determine a vehicle route for the autonomous vehicle 105 based at least in part on the map data 145.

The autonomous vehicle 105 can include a positioning system 150. The positioning system 150 can determine a current position of the autonomous vehicle 105. The positioning system 150 can be any device or circuitry for analyzing the position of the autonomous vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the autonomous vehicle 105 can be used by various systems of the vehicle computing system 100 and/or provided to a remote computing system. For example, the map data 145 can provide the autonomous vehicle 105 relative positions of the elements of a surrounding environment of the autonomous vehicle 105. The autonomous vehicle 105 can identify its position within the surrounding environment (e.g., across six axes, etc.) based at least in part on the map data 145. For example, the vehicle computing system 100 can process the sensor data 140 (e.g., LIDAR data, camera data, etc.) to match it to a map of the surrounding environment to get an understanding of the vehicle's position within that environment.

The autonomy computing system 130 can include a perception system 155, a prediction system 160, a motion planning system 165, and/or other systems that cooperate to perceive the surrounding environment of the autonomous vehicle 105 and determine a motion plan for controlling the motion of the autonomous vehicle 105 accordingly. For example, the autonomy computing system 130 can obtain the sensor data 140 from the vehicle sensor(s) 125, process the sensor data 140 (and/or other data) to perceive its surrounding environment, predict the motion of objects within the surrounding environment, and generate an appropriate motion plan through such surrounding environment. The autonomy computing system 130 can communicate with the one or more vehicle control systems 135 to operate the autonomous vehicle 105 according to the motion plan.

The vehicle computing system 100 (e.g., the autonomy computing system 130) can identify one or more objects that are proximate to the autonomous vehicle 105 based at least in part on the sensor data 140 and/or the map data 145. For example, the vehicle computing system 100 (e.g., the perception system 155) can process the sensor data 140, the map data 145, etc. to obtain perception data 170. The vehicle computing system 100 can generate perception data 170 that is indicative of one or more states (e.g., current and/or past state(s)) of a plurality of objects that are within a surrounding environment of the autonomous vehicle 105. For example, the perception data 170 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 155 can provide the perception data 170 to the prediction system 160 (and/or the motion planning system 165).

The prediction system 160 can be configured to predict a motion of the object(s) within the surrounding environment of the autonomous vehicle 105. For instance, the prediction system 160 can generate prediction data 175 associated with such object(s). The prediction data 175 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175 can be indicative of the speed and/or acceleration at which the respective object is predicted to travel along its associated predicted motion trajectory. The prediction system 160 can output the prediction data 175 (e.g., indicative of one or more of the predicted motion trajectories) to the motion planning system 165.

The vehicle computing system 100 (e.g., the motion planning system 165) can determine a motion plan 180 for the autonomous vehicle 105 based at least in part on the perception data 170, the prediction data 175, and/or other data. A motion plan 180 can include vehicle actions (e.g., planned vehicle trajectories, speed(s), acceleration(s), other actions, etc.) with respect to one or more of the objects within the surrounding environment of the autonomous vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 180. The motion planning system 165 can determine that the autonomous vehicle 105 can perform a certain action (e.g., pass an object, etc.) without increasing the potential risk to the autonomous vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the autonomous vehicle 105 (e.g., due to an overriding factor). In some implementations, the motion plan 180 may define the vehicle's motion such that the autonomous vehicle 105 avoids the object(s), reduces speed to give more leeway to one or more of the object(s), proceeds cautiously, performs a stopping action, etc.

The motion planning system 165 can be configured to continuously update the vehicle's motion plan 180 and a corresponding planned vehicle motion trajectory. For example, in some implementations, the motion planning system 165 can generate new motion plan(s) for the autonomous vehicle 105 (e.g., multiple times per second). Each new motion plan can describe a motion of the autonomous vehicle 105 over the next planning period (e.g., next several seconds). Moreover, a new motion plan may include a new planned vehicle motion trajectory. Thus, in some implementations, the motion planning system 165 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the autonomous vehicle 105.

The vehicle computing system 100 can cause the autonomous vehicle 105 to initiate a motion control in accordance with at least a portion of the motion plan 180. A motion control can be an operation, action, etc. that is associated with controlling the motion of the vehicle. For instance, the motion plan 180 can be provided to the vehicle control system(s) 135 of the autonomous vehicle 105. The vehicle control system(s) 135 can be associated with a vehicle controller (e.g., including a vehicle interface) that is configured to implement the motion plan 180. The vehicle controller can, for example, translate the motion plan into instructions for the appropriate vehicle control component (e.g., acceleration control, brake control, steering control, etc.). By way of example, the vehicle controller can translate a determined motion plan 180 into instructions to adjust the steering of the autonomous vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 180 (e.g., by sending control signal(s), making the translated plan available, etc.). This can allow the autonomous vehicle 105 to autonomously travel within the vehicle's surrounding environment.

The autonomous vehicle 105 can be associated with a variety of different parties. In some implementations, the autonomous vehicle 105 can be associated with a vehicle provider. The vehicle provider can include, for example, an owner, a manufacturer, a vendor, a manager, a coordinator, a handler, etc. of the autonomous vehicle 105. The vehicle provider can be an individual, a group of individuals, an entity (e.g., a company), a group of entities, a service entity, etc. In some implementations, the autonomous vehicle 105 can be included in a fleet of vehicles associated with the vehicle provider. The vehicle provider can utilize a vehicle provider computing system that is remote from the autonomous vehicle 105 to communicate (e.g., over one or more wireless communication channels) with the vehicle computing system 100 of the autonomous vehicle 105. The vehicle provider computing system can include a server system (e.g., of an entity), a user device (e.g., of an individual owner), and/or other types of computing systems.

The autonomous vehicle 105 can be configured to perform vehicle services for one or more service entities. An autonomous vehicle 105 can perform a vehicle service by, for example and as further described herein, travelling (e.g., traveling autonomously) to a location associated with a requested vehicle service, allowing user(s) and/or item(s) to board or otherwise enter the autonomous vehicle 105, transporting the user(s) and/or item(s), allowing the user(s) and/or item(s) to deboard or otherwise exit the autonomous vehicle 105, etc. In this way, the autonomous vehicle 105 can provide the vehicle service(s) for a service entity to a user.

A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services.

Each service entity can be associated with a respective telecommunications network system of that service entity. A telecommunications network system can include the infrastructure to facilitate communication between the autonomous vehicle 105 and the various computing systems of the associated service entity that are remote from the autonomous vehicle 105. For example, a service entity can utilize an operations computing system 200 to communicate with, coordinate, manage, etc. autonomous vehicle(s) to perform the vehicle services of the service entity. A telecommunications network system can allow an autonomous vehicle 105 to utilize the back-end functionality of the respective operations computing system 200 (e.g., vehicle service assignment allocation, vehicle technical support, etc.).

An operations computing system 200 can include one or more computing devices that are remote from the autonomous vehicle 105 (e.g., located off-board the autonomous vehicle 105). For example, such computing device(s) can be components of a cloud-based server system and/or other type of computing system that can communicate with the vehicle computing system 100 of the autonomous vehicle 105, another computing system (e.g., a vehicle provider computing system 210, etc.), a user device, etc. The operations computing system 200 can be, for example, a data center for the service entity. The operations computing system can be distributed across one or more location(s) and include one or more sub-systems. The computing device(s) of an operations computing system 200 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system (e.g., the one or more processors, etc.) to perform operations and functions, such as communicating data to and/or obtaining data from vehicle(s), etc.

In some implementations, the operations computing system 200 and the vehicle computing system 100 can indirectly communicate. For example, a vehicle provider computing system can serve as an intermediary between the operations computing system and the vehicle computing system 100 such that at least some data is communicated from the operations computing system 200 (or the vehicle computing system 100) to the vehicle provider computing system and then to the vehicle computing system 100 (or the operations computing system 200).

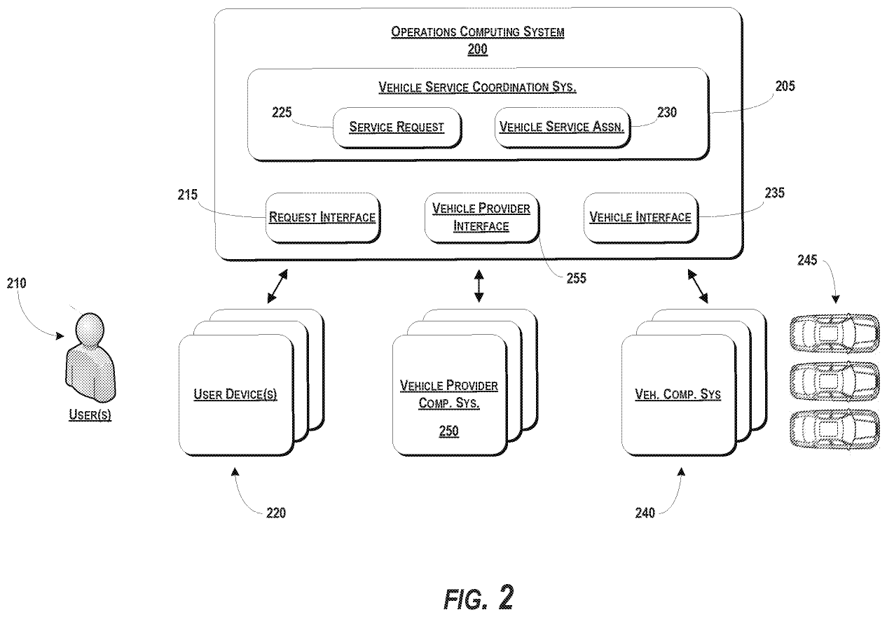

An operations computing system 200 can be configured to select and assign tasks to vehicles. FIG. 2 depicts the example operations computing system 200 according to example embodiments of the present disclosure. The operations computing system 200 can be associated with a service entity (e.g., service entities). The operations computing system 200 can include, for example, a vehicle service coordination system 205, and/or other systems.

The vehicle service coordination system 205 can be configured to coordinate the provision of one or more vehicle services to one or more users 210. For instance, the operations computing system 200 can include a request interface 215. The request interface 215 can allow the operations computing system 200 to communicate with one or a plurality of user devices 220 (e.g., mobile phones, desktops, laptops, tablets, game systems, etc.). The request interface 215 can allow the operations computing system 200 and the user device(s) 220 to communicate data to and/or from one another. For example, the user device(s) 220 can communicate (e.g., via the request interface 215) data indicative of a service request 225 for a vehicle service to an operations computing system 200 associated with a service entity.

The vehicle service coordination system 205 can be configured to generate a vehicle service assignment 230. A vehicle service assignment 230 can be indicative of a vehicle service (e.g., requested by a user via the user device(s) 220) to be performed by a vehicle (e.g., an autonomous vehicle). A vehicle service assignment 230 can include a variety of information associated with the vehicle service, the requesting user, the user device, the service entity, etc. For example, a vehicle service assignment 230 can include data indicative of an associated user and/or user device (if permitted), data indicative of a compensation parameter (e.g., the compensation for delivering an item to a user, couriering an item for a user, transporting a user, etc.), data indicative of one or more locations (e.g., origin location, destination location, intermediate location, etc.), data indicative of a type of vehicle service (e.g., transportation service, delivery service, courier service, etc.), data indicative of the type of cargo for the vehicle service (e.g., passengers, luggage, packages, food, time-sensitive mail, etc.), data indicative of a vehicle type/size (e.g., sedan, sport utility vehicle, luxury vehicle, etc.), data indicative of one or more time constraints (e.g., pick-up times, drop-off times, time limits for delivery, service duration, etc.), data indicative of user preferences (e.g., music, temperature, etc.), data indicative of one or more vehicle service parameters (e.g., luggage types, handle-with-care instructions, special pick-up requests, etc.), data indicative of the vehicle capacity required/preferred for the vehicle service (e.g., the number of seats with seatbelts, an amount of trunk space, etc.), data indicative of user ratings, data indicative of one or more vehicle service incentives (e.g., increased compensation, increased ratings, priority treatment, etc.), and/or other types of data.

The operations computing system 200 (e.g., the vehicle service coordination system 205) can identity one or more autonomous vehicles that are available for a vehicle service assignment 230. The vehicle service coordination system 205 can identify autonomous vehicle(s) that are online with the service entity associated with the operations computing system 200. The vehicle service coordination system 205 can select an autonomous vehicle for the vehicle service assignment based at least in part on the data indicated in the vehicle service assignment. For example, the vehicle service coordination system 205 can select an autonomous vehicle that meets the preferences of the user 210, has the necessary capacity, is the requested vehicle type, etc. Additionally, or alternatively, the vehicle service coordination system 205 can select an autonomous vehicle based at least in part on the current and/or future location of the autonomous vehicle. For example, the vehicle service coordination system 205 can select an autonomous vehicle that is proximate to an origin location associated with the vehicle service assignment 230. Additionally, or alternatively, the vehicle service coordination system 205 can select an autonomous vehicle that is within and/or nearby a geographic area that includes the origin location and/or destination location of the vehicle service assignment 230.

The operations computing system 200 can utilize a vehicle interface 235 to communicate data indicative of a vehicle service assignment 230 to one or more vehicle computing systems 240 of one or more autonomous vehicles 245. The vehicle computing system(s) 240 can include the vehicle computing system 100 and/or be configured in similar manner (e.g., as shown in FIG. 1) and the autonomous vehicle(s) 245 can include the autonomous vehicle 105. The vehicle interface 235 can allow the operations computing system 200 and one or a plurality of vehicle computing systems 240 (e.g., of one or a plurality of autonomous vehicles 245) to communicate data to and/or from one another. For example, the operations computing system 200 can communicate, via the vehicle interface 235, data indicative of a vehicle service assignment 230 to one or more vehicle computing system(s) 240 of the autonomous vehicles 245 that the operations computing system 200 selects for the vehicle service assignment 230. Additionally, or alternatively, the vehicle computing system(s) 240 can communicate data associated with the autonomous vehicle(s) 245 to the operations computing system 200. In this way, the operations computing system 200 can coordinate the performance of vehicle service(s) for user(s) by the autonomous vehicle(s) 245 as well as monitor the autonomous vehicle(s) 245.

In some implementations, the operations computing system 200 can select a non-autonomous vehicle (e.g., human driven vehicle) for a vehicle service assignment 230. For example, the vehicle service coordination system 205 can select a non-autonomous vehicle that is proximate to a location associated with the vehicle service assignment 230. Additionally, or alternatively, the vehicle service coordination system 205 can select a non-autonomous vehicle that is within and/or nearby a geographic area that includes the origin location and/or destination location of the vehicle service assignment 230. The operations computing system 200 can utilize a vehicle interface 235 to communicate data indicative of a vehicle service assignment 230 to one or more computing devices associated with the selected non-autonomous vehicle (e.g., a mobile device of the vehicle operator). The vehicle service assignment 230 can be indicative of a request that the operator provide the requested vehicle service to a user associated with the vehicle service assignment 230.

The operations computing system 200 can communicate with one or more vehicle provider computing systems 250 (associated with one or more vehicle providers) via a vehicle provider interface 255. The vehicle provider computing system(s) 250 can be associated with vehicle providers that are associated with the autonomous vehicle(s) 245. The vehicle provider interface 255 can allow the operations computing system 200 and one or a plurality of vehicle provider computing systems 250 (e.g., of one or more vehicle providers, etc.) to communicate data to and/or from one another. For example, the operations computing system 200 can communicate, via the vehicle provider interface 255, data indicative of a vehicle service assignment 230, and/or other data as described herein, to one or more vehicle provider computing system(s) 250. The vehicle provider computing system(s) 250 can then communicate such data to the vehicle computing system(s) 240. Additionally, or alternatively, the vehicle provider computing system(s) 250 can communicate data associated with one or more autonomous vehicles 245 (and/or other data) to the operations computing system 200.

A service entity may have varying levels of control over the vehicle(s) that perform its vehicle services. In some implementations, a vehicle can be included in the service entity's dedicated supply of vehicles. The dedicated supply can include vehicles that are owned, leased, or otherwise exclusively available to the service entity (e.g., for the provision of its vehicle service(s), other tasks, etc.) for at least some period of time. This can include, for example, an autonomous vehicle 245 that is associated with a vehicle provider, but that is online only with that service entity (e.g., available to accept vehicle service assignments for only that service entity, etc.) for a certain time period (e.g., a few hours, a day, week, etc.).

In some implementations, a vehicle can be included in the service entity's non-dedicated supply of vehicles. This can include vehicles that are not exclusively available to the service entity. For example, an autonomous vehicle 245 that is currently online with two different service entities so that the autonomous vehicle 245 may accept vehicle service assignment(s) 230 from either service entity (e.g., from the operations computing systems associated therewith, etc.) may be considered to be part of a non-dedicated supply of autonomous vehicles. In some implementations, whether a vehicle is considered to be part of the dedicated supply or the non-dedicated supply can be based, for example, on an agreement between the service entity and a vehicle provider associated with the autonomous vehicle 245.

An autonomous vehicle 245 can enter into an idle state while it is online with the service entity. An idle state can be a state in which the autonomous vehicle is online with a service entity and is not addressing a vehicle service assignment 230 and/or otherwise performing a vehicle service. This can include the time between vehicle service assignments 230. By way of example, an online autonomous vehicle can enter into an idle state after the autonomous vehicle 245 finishes performing a vehicle service for a first vehicle service assignment (e.g., drops off a user at a destination location in accordance with a service request). The idle state can, thus, indicate the time at which the autonomous vehicle is available to perform a vehicle service but is not currently performing and/or assigned to one (e.g., traveling to an origin location, transporting an item/user, traveling to a destination location, etc.).

A computing system associated with a service entity can aim to pre-emptively reduce the amount of potential time that an autonomous vehicle 245 is in an idle state (inefficiently using its computational resources) by evaluating and selecting certain operational domains for an autonomous vehicle 245. An autonomous vehicle 245 can operate within an operational domain, for example, to provide vehicle services. An operational domain can be an environment in which an autonomous vehicle 245 has, is, or may potentially operate. For example, an operational domain can include a geographic area. The geographic area can be a market in which vehicles associated with the service entity (e.g., non-autonomous vehicles, autonomous vehicles, etc.) currently operate or a potential market in which vehicles associated with the service entity may potentially operate in the future. An operational domain may include a city, town, other municipality, etc. In some implementations, an operational domain can include one or more sub-regions. For example, the operational domain can include a city with one or more neighborhoods. Moreover, the operational domain can include travel ways (e.g., roads, streets, pathways, intersections, etc.). The travel ways can include lanes and/or other designated portions for a vehicle to travel on the travel ways.

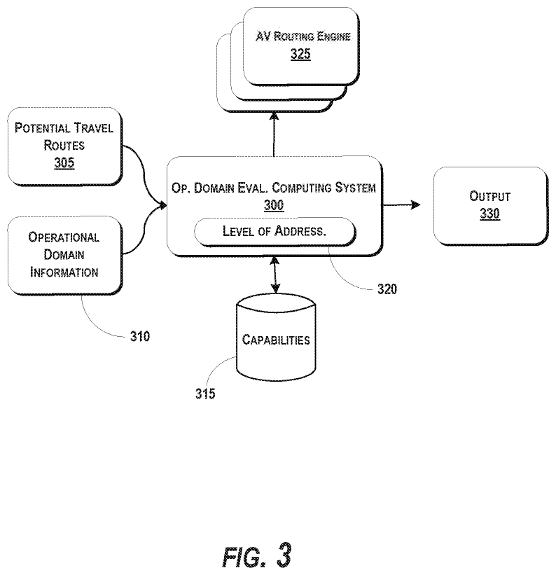

A computing system (e.g., associated with a service entity) can evaluate various operational domains to determine which would be most appropriate for the operation of autonomous vehicles 245. FIG. 3 depicts an example operational domain evaluation computing system 300 (“ODE computing system 300”) according to example embodiments of the present disclosure. The ODE computing system 300 can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the ODE computing system 300 (e.g., its one or more processors, etc.) to perform operations and functions, such as those described herein.

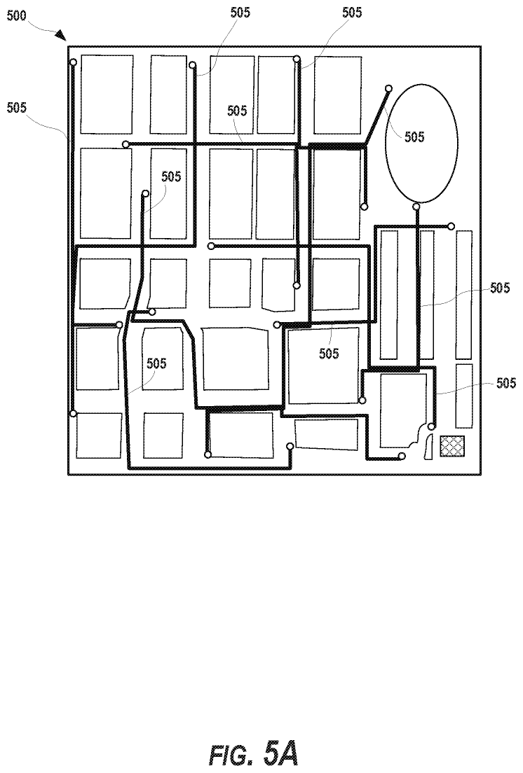

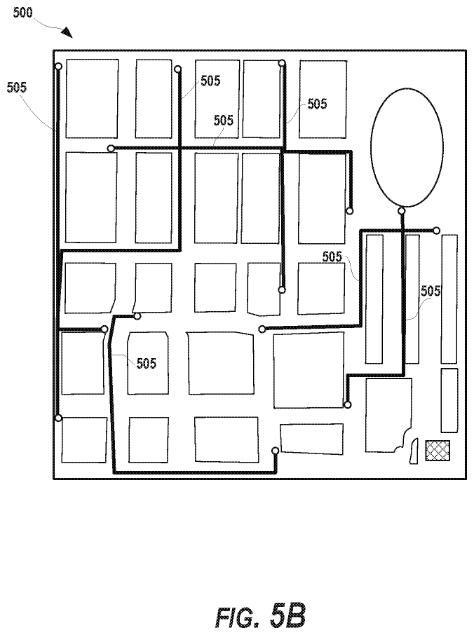

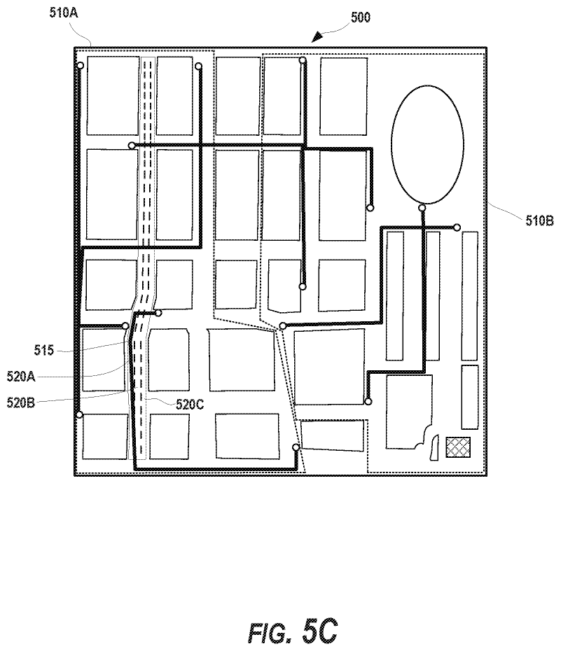

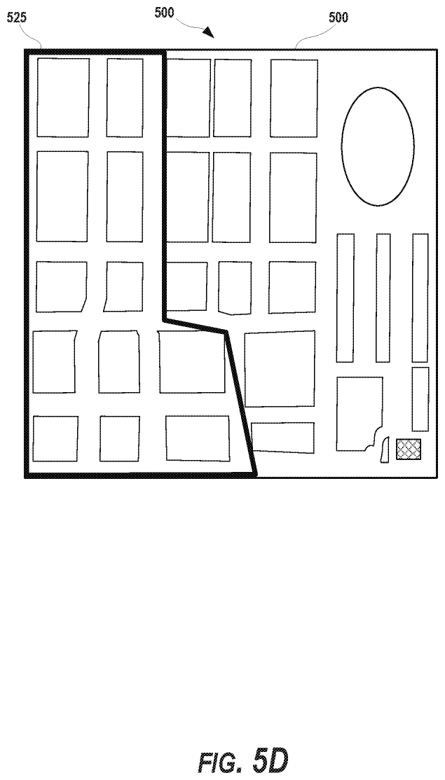

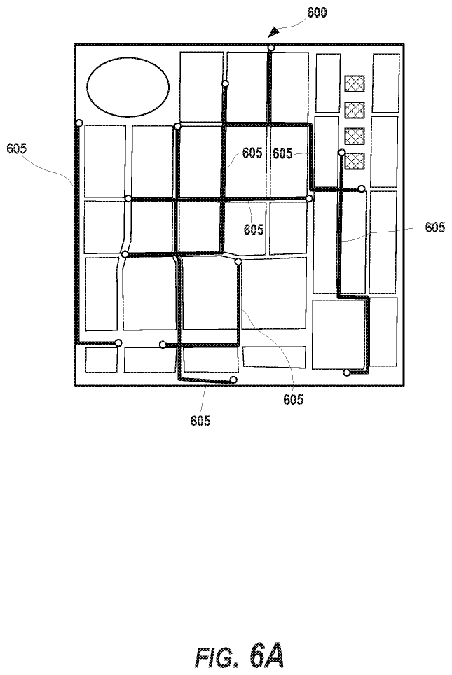

The ODE computing system 300 can identify one or more operational domains. The operational domain(s) can include, for example, geographic areas in which a service entity may consider utilizing autonomous vehicles to provide vehicle services. For instance, this may include a city in which transportation services are currently provided by non-autonomous vehicles (and their operators), but not autonomous vehicles. In some implementations, identified operational domain(s) can include geographic area(s) in which a service entity does not utilize any vehicles (non-autonomous or autonomous) to provide vehicle services. This can include, for example, markets that are being serviced by other service entities. In some implementations, the identified operational domain(s) can include geographic area(s) in which a service entity previously and/or currently utilizes both non-autonomous and autonomous vehicles to provide vehicle services, but aims to conduct further analysis of the geographic area. FIGS. 5A-D depict a first example operational domain 500 and the FIGS. 6A-B depict a second example operational domain 600.

To help evaluate an operational domain, the ODE computing system 300 can obtain data 305 associated with a plurality of potential travel routes within the operational domain. The data 305 associated with the plurality of potential travel routes can be obtained via a local memory and/or a remote memory that stores travel route data associated with operational domain(s). Each of the plurality of potential travel routes can start and end within the operational domain.

By way of example, FIG. 5A depicts a first operational domain 500 and a plurality of potential travel routes 505 within the operational domain 500. Each of the plurality of potential travel routes 505 can start and end within the first operational domain 500 (e.g., its associated geographic area). In some implementations, the plurality of travel routes 505 can be based at least in part on the travel routes within the operational domain 500 that can be traversed by non-autonomous, human-driven vehicles. For example, the service entity may leverage non-autonomous vehicles (and their operators) to provide vehicle services in the first operational domain 500. Data indicative of the routes that these non-autonomous vehicles take throughout the first operational domain to provide vehicle services can be acquired. For instance, the non-autonomous vehicles can include positioning systems (e.g., GPS and/or other positioning systems) that can allow the location of the non-autonomous vehicle to be monitored, tracked, recorded, and/or stored (if permitted by the operator). In this way, the routes traversed by these non-autonomous vehicles can be tracked and stored (if permitted).

With reference to FIG. 3, the data 305 indicative of the plurality of potential travel routes can be determined based on a variety of information. For instance, the ODE computing system 300 can determined the plurality of potential travel routes within the operational domain of the autonomous vehicle based at least in part on at least one of: historic travel route data, simulated travel route data, or predicted travel route data.

In some implementations, the plurality of travel routes can be based on historical travel route data. For example, as described herein, the ODE computing system 300 can obtain data indicative of the travel routes previously traversed by non-autonomous vehicles when providing vehicle services within the operational domain (e.g., when transporting users from one location to another, transporting item(s), etc.). These historically travelled routes can provide real-world examples of the types of routes that may need to be utilized by autonomous vehicles to provide vehicle services within the operational domain. In some implementations, the historic travel route data can be constrained to a particular time period (e.g., within the past 4 months, 6 months, 12 months, 24 months, etc.).

Additionally, or alternatively, the plurality of travel routes can be based at least in part on simulated travel route data. For example, a simulation can be run to generate a number of simulated travel routes in an operational domain (e.g., the first operational domain 500) given a variety of vehicle service requests. This can allow an operational domain to be evaluated without real-world travel route data associated therewith (e.g., for prospective markets with little or no vehicle presence).

Additionally, or alternatively, the plurality of travel routes can be based at least in part on predicted travel route data. For example, the plurality of travel routes for one operational domain (e.g., the first operational domain 500) can be predicted based on the real-world and/or simulated travelled routes extrapolated from another operational domain (e.g., the second operational domain 600). The two operational domains can have similar travel ways, infrastructure, weather conditions, and/or other characteristics/circumstances.

In some implementations, the ODE computing system 300 can obtain information 310 associated with an operational domain (other than the plurality of travel routes). The information 310 can be indicative of at least one of weather associated with the operational domain, a regulation or policy associated with the operational domain, a lighting condition associated with the operational domain, object data associated with the operational domain, and/or other information.

For instance, the ODE computing system 300 can obtain information indicative the weather associated with an operational domain. Such information can indicate where, how often, and how much snow, rain, sleet, and/or other weather conditions are experienced by the operational domain. The information indicative the weather associated with an operational domain can be acquired via a memory that stores such information and/or obtained via another computing system (e.g., a weather tracking computing system).

Additionally, or alternatively, the ODE computing system 300 can obtain information indicative of a regulation or policy associated with an operational domain. For example, an operational domain may have regulations that restrict autonomous vehicles from operating in certain portions of the operational domain. In another example, an operational domain may have certain restrictions regarding the lanes that can be utilized by an autonomous vehicle. In another example, an operational domain may have certain restrictions regarding the times of day that an autonomous vehicle can be operated in the operational domain. The information indicative of the regulations or policies associated with an operational domain can be acquired via a memory that stores such information and/or obtained via another computing system (e.g., a regulation/policy database).

Additionally, or alternatively, the ODE computing system 300 can obtain information indicative of a lighting condition associated with an operational domain. This information can be indicative of the level of lighting of the travels ways (e.g., frequency, brightness, and/or other characteristics of street lamps, etc.) within the operational domain. Additionally, or alternatively, this information can be indicative of a level of sun exposure experienced (or predicted to be experienced) by the operational domain (e.g., the daily hours of sunlight, brightness of the sunlight, etc.). Additionally, or alternatively, this information can be indicative of conditions within the operational domain that may impact the lighting conditions (e.g., tree coverage, cloud coverage, other obstructions, etc.).

In some implementations, the ODE computing system 300 can obtain object data associated with an operational domain. The object data can be indicative of the types, numbers, trends, etc. of the objects within the operational domain. For example, the object data can indicate whether a particular operational domain has a high number of trees, pedestrians, bicyclists, etc.

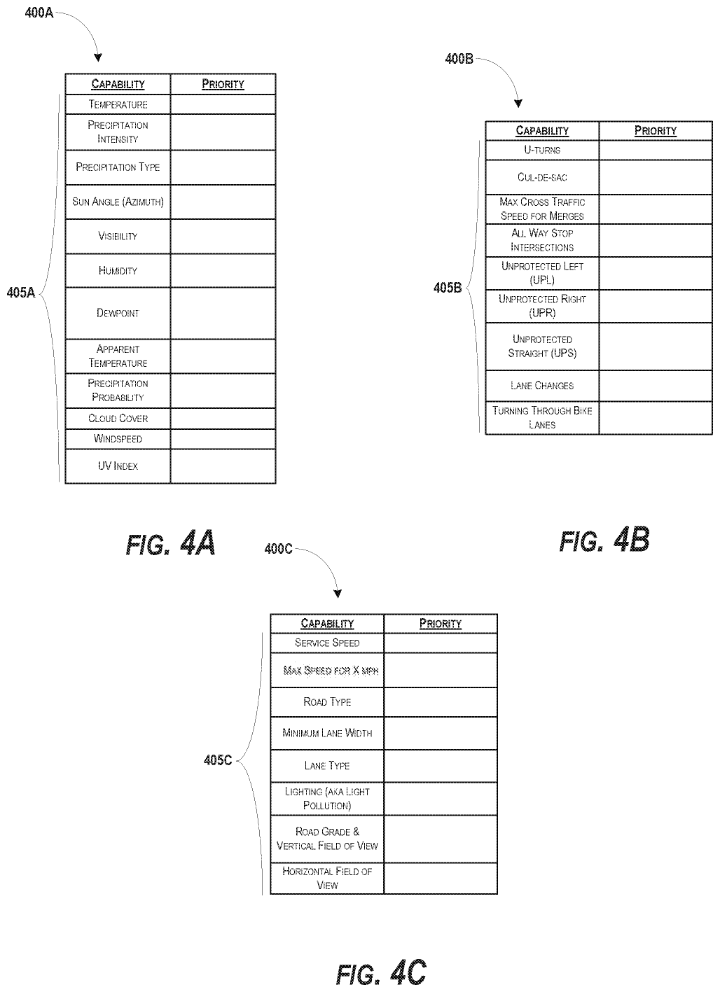

The ODE computing system 300 can evaluate operational domain(s) based at least in part on one or more vehicle capabilities. A capability can be indicative of an ability of an autonomous vehicle such as, for example, an ability that helps the vehicle autonomously operate (e.g., with little or no operator input). The ODE computing system 300 can obtain data 315 indicative of one or more capabilities of an autonomous vehicle from a local and/or remote memory that stores such data (e.g., a cache, etc.). FIGS. 4A-C depict example data structures 400A-C (e.g., tables, lists, etc.) that include data indicative of capabilities of an autonomous vehicle according to example embodiments of the present disclosure. Such data structures can be stored in the local and/or remote memory for access by the ODE computing system 300.

In some implementations, the capabilities can be indicative of the vehicle's ability to operate (e.g., perceive its surroundings, predict object motion, plan vehicle motion, etc.) in certain weather condition(s) (e.g., rain, snow, sleet, etc.). For example, FIG. 4A depicts an example data structure 400A that includes data indicative of a plurality of vehicle capabilities 405A associated with weather condition(s). These weather condition(s) can include, for example, temperature (e.g., range, min/max, etc.), precipitation intensity (e.g., max allowable, inches per hour, etc.), precipitation type (e.g., rain, snow, sleet, etc.—binary yes/no), sun angle (azimuth) (e.g., range, between x and y, etc.), visibility (e.g., no less than X ft., etc.), humidity (max allowable, etc.), dewpoint (e.g., range, min/max, etc.), apparent temperature (e.g., range, min/max, etc.), precipitation probability (e.g., max allowable, etc.), cloud cover (e.g., range, min/max, etc.), windspeed (e.g., max allowable, mph, etc.), UV index (e.g., max allowable, ranges, etc.), windbearing, icon, and/or other conditions. A capability of the vehicle associated with the weather conditions can indicate that the autonomous vehicle can still normally operate (e.g., perceive objects, predict motion, plan its motion, control its motion, etc.) with acceptable accuracy, with acceptable error, with acceptable confidence, etc. given the particular weather condition. For example, a temperature capability can indicate that the autonomous vehicle can operate normally within a temperature range of X degrees to Y degrees. In another example, a precipitation type capability can indicate that the autonomous vehicle can operate normally in rain, snow, sleet, etc.

Additionally, or alternatively, the capabilities can be indicative of a vehicle maneuverability. For example, FIG. 4B depicts an example data structure 400B that includes data indicative of a plurality of vehicle capabilities 405B associated with vehicle maneuverability. These capabilities can indicate whether the autonomous vehicle is able to perform the particular maneuver. For instance, these capabilities can indicate that an autonomous can (or cannot) perform: a u-turn, a maneuver in a cul-de-sac (e.g., turn-around), a merge maneuver (e.g., a max traffic speed at which the vehicle can merge into a lane), a maneuver at an all way stop (e.g., evaluate and operate under right-of-way conditions, etc.), a unprotected left turn, an unprotected right turn, a unprotected straight, a lane change, a turn through a bike lane (if bike lane is unoccupied and such maneuver is legal and required in an operational domain), and/or other operating scenarios of the autonomous vehicle.

Additionally, or alternatively, the capabilities can be indicative of vehicle operating condition(s). For example, FIG. 4C depicts an example data structure 400C that includes data indicative of a plurality of vehicle capabilities 405C associated with vehicle operating condition(s). These capabilities can indicate the certain operating restrictions of an autonomous vehicle. For instance, these capabilities can indicate the following: a speed (e.g., max time) at which a vehicle should complete a vehicle service, a maximum travelling speed of the vehicle (e.g., the speed at which the vehicle can travel), whether the vehicle is available to traverse, or is restricted from, certain road types (e.g. alley, driveway, highway, etc.), minimum lane width, lane type (e.g., normal non-auto, routable, etc.), lighting (e.g., light pollution, brightness needed, etc.), road grade and vertical field of view (e.g., grade no greater than X%/lower than Y%, vertical field of view within certain range, etc.), horizontal field of view (e.g., min field of view in degrees, etc.), and/or other operating conditions of the autonomous vehicle.

Returning to FIG. 3, for each respective operational domain (e.g., identified operational domain(s) of interest), the ODE computing system 300 can determine a level of addressability 320 associated with an operational domain based at least in part on the one or more capabilities 405A-C of the autonomous vehicle and the plurality of potential travel routes within the respective operational domain. In some implementations, the level of addressability 320 can be determined based at least in part on the other information associated with the operational domain (e.g., weather data, regulation/policy data, lighting conditions, object data, etc.). The level of addressability 320 can be indicative of the ability of an autonomous vehicle to operate within an operational domain. Moreover, the level of addressability can be indicative of the level of usage that an autonomous vehicle may experience in an operational domain (e.g., for performing vehicle services).

To determine the level of addressability 320 of an operational domain, the ODE computing system 300 can determine the number of the potential travel routes that are traversable by an autonomous vehicle within the respective operational domain based at least in part on the one or more capabilities 405A-C of the autonomous vehicle. To do so, the ODE computing system 300 can access and/or otherwise leverage an autonomous vehicle computing engine 325. The autonomous vehicle computing engine 325 can be a computing system (with one or more processor(s) and one or more memory) configured to evaluate the performance of an autonomous vehicle. The autonomous vehicle computing engine 325 can be programed based at least in part on one or more software stacks that are the same as or at least similar to the software stack utilized on an autonomous vehicle (e.g., autonomous vehicle 105), outside of a testing environment. The software stack(s) utilized in the autonomous vehicle computing engine 325 can also, or alternatively, include software (e.g., an updated version) that has not been deployed onto an autonomous vehicle (e.g., a software version associated with a newly developed vehicle capability). The autonomous vehicle computing engine 325 can be utilized to determine whether an autonomous vehicle would be capable of traversing a particular travel route given the capabilities of the autonomous vehicle. The autonomous vehicle computing engine 325 can utilize map data, driving log data, sensor data, traffic data, weather data, and/or other data associated with an operational domain to learn about the travel route conditions of a potential travel route (e.g., number/width/configuration./etc. of lanes, grade, visibility, speed limit, traffic, required manuverabilities, etc.) and whether an autonomous vehicle (with the given capabilities) would be able to traverse that potential travel route in those conditions. For instance, the ODE computing system 300 can obtain data indicative of a capability 405A-C of an autonomous vehicle. The ODE system 300 can communicate and/or otherwise incorporate the capability 405A-C to the autonomous vehicle computing engine 325 and leverage the functionality of the autonomous vehicle computing engine 325 to determine whether an autonomous vehicle 105 can traverse a potential travel route (e.g., within an operational domain), given that capability 405A-C of the autonomous vehicle.

By way of example, with reference to FIG. 5A, the ODE computing system 300 can obtain data indicative of a plurality of potential travel routes 505 within a first operational domain 500 (e.g., City A). The potential travel routes 505 can be, for example, based at least in part on the real-world travel routes of City A that have been traversed by non-autonomous vehicles while providing vehicle services (e.g., transporting users) within the last twelve months. The ODE computing system 300 can determine how many of the potential travel routes 505 would be traversable by an autonomous vehicle in the event that the autonomous vehicle had one or more capabilities 405A-C (e.g., the ability to make an unprotected left turn, the ability to make an unprotected right turn, make a U-turn, etc.). The ODE computing system 300 can leverage the functionality of the autonomous vehicle computing engine 325 to filter the potential travel routes 505 to determine which of the potential travel routes 505 would be traversable. For example, the ODE computing system 300 can determine that the potential travel routes 505 shown in FIG. 5B are the ones that would be traversable by an autonomous vehicle given the capabilities 405A-C of the autonomous vehicle under evaluation and the travel route conditions of the potential travel routes 505 shown in FIG. 5B.

The ODE computing system 300 can also, or alternatively, determine how many of the potential travel routes 505 shown in FIG. 5A would not be traversable by an autonomous vehicle in the event that the autonomous vehicle did not have a particular capability 405A-C (e.g., did not have the ability to make an unprotected left turn, U-turn, etc.). For example, the ODE computing system 300 can determine that the potential travel routes not shown in FIG. 5B are the ones that would not be traversable by an autonomous vehicle given the capabilities 405A-C under evaluation and the travel route conditions of those potential travel routes.

Additionally, or alternatively, the ODE computing system 300 can filter the plurality of potential travel routes 505 based at least in part on the information 310 associated with an operational domain. By way of example, in the event that one or more of the potential travel routes 505 shown in FIG. 5A go through areas that prohibit autonomous vehicle operation, those potential travel routes would be identified as not being traversable by an autonomous vehicle.

The ODE computing system 300 can determine a level of addressability 320 for the first operational domain 500 based at least in part on the potential travel routes within the first operational domain 500 that are traversable by an autonomous vehicle. The level of addressability 320 can be calculated based on various factor(s). In some implementations, the level of addressability 320 can be based at least in part on the number of potential travel routes 505 that are determined to be traversable by an autonomous vehicle as shown in FIG. 5B. The level of addressability 320 can be higher for a higher number of potential travel routes. The number of traversable potential travel routes 505 can be represented as an integer, a percentage (e.g., 50%), a fraction (e.g., 50 out of 100 routes), and/or another type of classification (e.g., low, moderate, high, etc.).

In some implementations, the level of addressability 320 can be measured based on a travel distance associated with the number of the potential travel routes 505 that are traversable by the autonomous vehicle 105. This can include an aggregate number of miles, kilometers, etc. of the potential travel routes 505 that are traversable by an autonomous vehicle (e.g., as shown in FIG. 5B). This distance can represent a potential amount of distance that would be travelled by an autonomous vehicle while performing vehicle services. The level of addressability 320 can be higher for a greater distance (e.g., reflecting a reduced amount of potential idle time). The travel distance can be represented as an integer (e.g., 75 miles, etc.), a percentage (75% of the possible mileage, etc.), a fraction (e.g., 75/100 miles, etc.), and/or another type of classification (e.g., low, moderate, high, etc.).

In some implementations, the level of addressability 320 can be based at least in part on a predicted service time associated with the potential travel routes 505 that are traversable by the autonomous vehicle 105. For example, the ODE computing system 300 can determine an aggregate amount of time that an autonomous vehicle would be travelling along the traversable travel routes (e.g., when addressing service requests). A greater amount of time can be indicative of a greater usage rate (and less idle time). In such an example, the longer the amount of service time, the higher the level of addressability 320. The service time can be represented as an integer, a percentage, a fraction, and/or another type of classification (e.g., low, moderate, high, etc.).

In some implementations, the level of addressability 320 can be based at least in part on a predicted number of service requests associated with the potential travel routes 505 that are traversable by the autonomous vehicle 105. For example, as described herein, the potential travel routes 505 can be associated with real-world travel routes that were traversed by non-autonomous vehicles while performing a vehicle service in accordance with a user's service request (e.g., transporting a user to a requested destination). Each of potential travel routes 505 can be associated with a projected number of service requests/assignments that is based at least in part on an associated number of real-world service requests. A higher number of predicted service requests/assignments can be indicative of a higher potential usage rate (and lower idle time) of an autonomous vehicle. Accordingly, the first operational domain 500 can be afforded a higher level of addressability 320 for a greater number of predicted service requests.

Additionally, or alternatively, the level of addressability 320 can be based at least in part on a level of predicted revenue (and/or profit) associated with the potential travel routes 505 that are traversable by the autonomous vehicle 105 (e.g., the routes shown in FIG. 5B). The level of revenue (and/or profit) can be calculated based on the projected service requests/assignments associated with the potential travel routes 505. The level of revenue (and/or profit) can be represented as an integer, a percentage, a fraction, and/or another type of classification (e.g., low, moderate, high, etc.).

In some implementations, the level of addressability 320 can be based at least in part on the predicted computational resource(s) that an autonomous vehicle may utilize while traversing the potential travel route(s) 505. For instance, the ODE computing system 300 can leverage the autonomous vehicle computing engine 325 to determine the processing resources, memory resources, bandwidth, power, etc. that may be utilized by an autonomous vehicle while traversing a potential travel route 505. The level of addressability 320 may be lower in the event that the predicted resource utilization is higher (e.g., per distance traveled). This may reflect a more inefficient usage of the vehicle's resources within the first operational domain 500. The predicted level of resource utilization can be represented as a rate (e.g., unit per time), an integer, a percentage, a fraction, and/or another type of classification (e.g., low, moderate, high, etc.).

In some implementations, the level of addressability 320 can be based at least in part on a comparison of how a vehicle service would be performed by a non-autonomous vehicle versus how the vehicle service would be performed by an autonomous vehicle. For example, the ODE computing system 300 can obtain data that indicates a pick-up location, travel route, destination location, and travel time associated with a first vehicle service that transports a user from one location to another within the first operational domain 500 via a non-autonomous vehicle. This data can be based at least in part on real-world data. In some implementations, a simulation can be run to determine these parameters in the event that an autonomous vehicle is used to transport the user for the first vehicle service or such real-world data does not exist. The ODE computing system 300 can compare this information to see whether an autonomous vehicle 105 would perform the vehicle service as well as the non-autonomous vehicle. For example, in the event that the service time is substantially similar (e.g., within 30 seconds, 1 minute, etc.) and the non-autonomous vehicle is able to get similarly close to the pick-up and destination locations (e.g., within 10 m, 20 m, etc.), the level of addressability 320 can be increased. However, in the event that the autonomous vehicle 105 would take significantly longer to complete the vehicle service and/or be unable to arrive proximate to the pick-up and/or destination locations, the level of addressability 320 can be decreased.

The ODE computing system 300 can evaluate multiple capabilities 405A-C across an operational domain to determine which capabilities 405A-C would have the greatest effect on the level of addressability 320 for that operational domain. For instance, as described herein, the ODE computing system 300 can obtain data indicative of one or more capabilities of an autonomous vehicle. The one or more capabilities can include a first capability of the autonomous vehicle (e.g., the ability to operate in heavy snow) and a second capability of the autonomous vehicle (e.g., the ability to perform an unprotected left turn). The ODE computing system 300 can determine the level of addressability 320 for a first operational domain 500 (e.g., City A) for each capability. For example, the computing system can determine a first level of addressability for the first operational domain (e.g., City A) based at least in part on the first capability of the autonomous vehicle (e.g., the ability to operate in heavy snow). The ODE computing system 300 can determine a second level of addressability for the first operational domain 500 based at least in part on the second capability of the autonomous vehicle (e.g., the ability to perform an unprotected left turn). This can include, for instance, filtering the potential travel routes 505 (as shown from FIG. 5A to FIG. 5B) based at least in part on the first capability or second capability to determine one or more of: the number of potential travel routes 505 that would be traversable by an autonomous vehicle, a travel distance associated with the number of the potential travel routes 505 that are traversable by an autonomous vehicle, a predicted number of service requests associated with the potential travel routes 505 that are traversable by an autonomous vehicle, a predicted service time associated with the potential travel routes 505 that are traversable by an autonomous vehicle, a predicted resource utilization associated with the potential travel routes 505 that are traversable by an autonomous vehicle, and/or a predicted level of revenue associated with the potential travel routes 505 that are traversable by an autonomous vehicle. In this way, the ODE computing system 300 can determine what the level of addressability 320 would be for the first operational domain 500 (e.g., City A) in the event that an autonomous vehicle has the first capability (e.g., was able to operate in heavy snow) and/or the second capability (e.g., was able to perform an unprotected left turn).

The ODE computing system 300 can compare the first level of addressability and the second level of addressability to help determine which capability would lead to higher vehicle usage in the first operational domain 500. By way of example, the second capability (e.g., the ability to perform an unprotected left turn) may lead to a higher level of addressability for the first operational domain 500 than the first capability (e.g., the ability to operate in heavy snow) in the event that the second capability would allow for a greater number of traversable potential travel routes 505, travel distance, projected service requests, service time, projected revenue, more efficient resource usage, etc. in the first operational domain 500. The ODE computing system 300 can continue this analysis by iterating over additional capabilities and/or operational domains. As further described herein, the ODE computing system 300 can ultimately recommend that the development of one of the capabilities (e.g., the ability to perform unprotected left turns) be prioritized over the development of another (e.g., the ability to operate in heavy snow).

Additionally, or alternatively, the ODE computing system 300 can iterate its analysis across multiple operational domains given one or more capabilities 405A-C. For instance, the ODE computing system 300 can compare the different levels of addressability across the various operational domains to help determine which operational domains may lead to higher autonomous vehicle utilization (and less idle time).

By way of example, the ODE computing system 300 can identify operational domain(s). The operational domain(s) can include a first operational domain 500 as shown in FIGS. 5A-D (e.g., City A) and a second operational domain 600 as shown in FIGS. 6A-B (e.g., City B). For each of the operational domain(s), the ODE computing system 300 can obtain data associated with a plurality of potential travel routes within the respective operational domain. For instance, the ODE computing system 300 can obtain data associated with a plurality of potential travel routes 505 within the first operational domain 500 (e.g., as shown in FIG. 5A). The ODE computing system 300 can obtain data associated with a plurality of potential travel routes 605 within the first operational domain 600 (e.g., as shown in FIG. 6A).

For each respective operational domain, the ODE computing system 300 can determine a respective level of addressability 320 for comparison. For instance, the ODE computing system 300 can determine a first level of addressability for the first operational domain 500 based at least in part on the one or more capabilities 405A-C of the autonomous vehicle (e.g., ability to operate in heavy snow, ability to perform an unprotected left turn, etc.) and a first plurality of potential travel routes 505 within the first operational domain 500. This can include filtering the plurality of potential travel routes 505 within the first operational domain 500 based at least in part on the one or more capabilities 405A-C and/or other information (e.g., regulations/policies, etc.). As a result of such filtering, the ODE computing system 300 can determine the potential travel routes 505 that are predicted to be traversable by the autonomous vehicle (as shown in FIG. 5B). The ODE computing system 300 can determine a second level of addressability for the second operational domain 600 based at least in part on the one or more capabilities 405A-C of the autonomous vehicle and a second plurality of potential travel routes 605 within the second operational domain 600. This can include filtering a plurality of potential travel routes 605 within the second operational domain 600 based at least in part on the one or more capabilities 405A-C and/or other information (e.g., regulations/policies, etc.).

The ODE computing system 300 can compare the levels of addressability of the first operational domain 500 and the second operational domain 600 to determine which operational domain has a higher likelihood of decreasing autonomous vehicle idle time. For example, in the event that the first level of addressability for the first operational domain 500 is higher than the second level of addressability for second operational domain 600, then the ODE computing system 300 can determine that the first operational domain 500 (e.g., City A) would be a more appropriate operational domain for an autonomous vehicle 105 (e.g., due to a higher predicted utilization rate). As further described herein, this can allow the ODE computing system 300 to prioritize different operational domains.

In some implementations, the ODE computing system 300 can evaluate operational domain(s) on a more granular level. For instance, an operational domain can include a plurality of sub-regions (e.g., neighborhoods and/or other areas.). The ODE computing system 300 can identify the plurality of sub-regions of the operational domain. The ODE computing system 300 can determine a respective level of addressability 320 for each of the sub-regions of the operational domain. For instance, ODE computing system 300 determine a level of addressability 320 for each of the sub-region(s) in a similar manner to that described herein for an overall operational domain.

By way of example, as shown in FIG. 5C, a first operational domain (e.g., City A) can include a first sub-region 510A (e.g., Neighborhood X) and a second sub-region 510B (e.g., Neighborhood Y). For each sub-region 510A-B, the ODE computing system 300 can determine a level of addressability 320 based at least in part on the potential travel routes within that sub-region 510A-B and one or more capabilities 405A-C of the autonomous vehicle. For example, for the first sub-region 510A, the ODE computing system 300 can filter the potential travel routes within the first sub-region 510A based at least in part on the one or more capabilities 405A-C of the autonomous vehicle and other information associated with the first sub-region 510A (e.g., regulations, policies, etc.). This can allow the ODE computing system 300 to determine which potential travel routes within the first sub-region 510A are traversable by the autonomous vehicle. The ODE computing system 300 can determine a level of addressability 320 for the first sub-region 510A based at least in part on the potential travel routes within the first sub-region 510A that are traversable by the autonomous vehicle (e.g., the number of routes, service distance, service time, etc.). For the second sub-region 510B, the ODE computing system 300 can filter the potential travel routes within the second sub-region 510B based at least in part on the one or more capabilities 405A-C of the autonomous vehicle 105 and other information associated with the first sub-region 510B (e.g., regulations, policies, etc.). This can allow the ODE computing system 300 to determine which potential travel routes within the first sub-region 510B are traversable by the autonomous vehicle. The ODE computing system 300 can determine a level of addressability for the second sub-region 510B based at least in part on the potential travel routes within the second sub-region 510B that are traversable by the autonomous vehicle (e.g., the number of routes, service distance, service time, etc.). The ODE computing system 300 can compare the respective levels of addressability and determine whether the first or the second sub-region 510A-B may lead to higher vehicle usage rates (and less idle time) (e.g., as reflected by a higher level of addressability). As further described herein, this can at least help determine the boundaries within which an autonomous vehicle can operate in an operational domain and/or suggested retrieval and drop-off locations.

Additionally, or alternatively, the ODE computing system 300 can be configured to evaluate one or more travels ways and/or potential travel routes within a sub-region. For example, the ODE computing system 300 can determine which travels way(s) and/or potential travel route(s) may be the most appropriate for an autonomous vehicle. As described herein, a sub-region (e.g., a neighborhood, etc.) can include a plurality of travel ways (e.g., roads, etc.). The travel ways can include lanes and/or other designated portions for traversing the travel ways. The ODE computing system 300 can obtain data indicative of a plurality of potential travel routes that utilize the travel ways within that sub-region. The ODE computing system 300 determine which travel ways, lanes, other designated portions, etc. would be most efficient for an autonomous vehicle when traversing the potential travel route.

By way of example, as shown in FIG. 5C, the first sub-region 510A of the first operational domain 500 can include a first travel way 515. The first travel way 515 can include a plurality of lanes 520A-C. The ODE computing system 300 can determine a level of addressability 320 of the first travel way 515 and/or an individual lane 520A-C. For example, the ODE computing system 300 can determine a level of addressability 320 of the first travel way 515 based at least in part on the number of potential travel routes utilizing the first travel way 515, a number of projected service requests/assignments (e.g., historical/simulated/predicted service requests/assignments that would involve using the first travel way, etc.), a regulation or policy associated with the first travel way 515, an estimated travel time associated with travel way, travel way configuration (e.g., intersections, cross-walks, bike lanes, etc.), and/or other conditions of the first travel way 515 (e.g., traffic, time/turn restrictions, etc.). Additionally, or alternatively, the ODE computing system 300 can determine a level of addressability 320 for each respective lane 520A-C based at least in part on the one or more capabilities 405A-C of the autonomous vehicle (e.g., whether a lane would require an unprotected straight), a number of projected service requests (e.g., which side of the street has more pick-up locations), a regulation or policy (e.g., whether a particular lane allows for autonomous vehicle operation), an estimated travel time (e.g., whether travel time would take longer in a certain lane), and/or other conditions of the lane (e.g., whether a particular lane allows for autonomous vehicles, is under construction, is nearby a bike lane, traffic patterns, etc.). For example, a first lane 520B (e.g., the center lane) that is not under construction can have a higher level of addressability than a second lane 520C (e.g., the left lane) that is under construction or a third lane 520A (e.g., the right lane) that is more prone to stop-and-go traffic. Such analysis can allow the ODE computing system 300 to formulate a recommendation as to which potential travel routes, travel ways, and/or lanes within an operational domain would be more efficient for an autonomous vehicle.

Returning to FIG. 3, the ODE computing system 300 can initiate an action based at least in part on one or more of the respective levels of addressability associated with the one or more operational domains. For instance, the ODE computing system 300 can provide an output 330 based at least in part on one or more of the respective levels of addressability associated with the one or more operational domains. In some implementations, ODE computing system 300 can output data indicative of the level(s) of addressability 320 for operational domain(s). For example, the ODE computing system 300 can generate and output a report that indicates the level(s) of addressability for a first operational domain 500 based at least in part on one or more capabilities 405A-C. The report can indicate level(s) of addressability 320 for a first operational domain 500 given a first capability, a second capability, a third capability, etc. The report can additionally, or alternatively, be indicative of a variety of parameters associated with the first operational domain 500 including, for example: a projected number of total vehicle services to be performed by an autonomous vehicle, a gross number of historic/estimated service requests/assignments, projected service distance, projected service time, revenue/profit data, etc. Such projections can be based at least in part on historic data associated with the first operational domain 500 (e.g., data associated with vehicle services provided via non-autonomous vehicles, etc.) and/or other data (e.g., data from other operational domains with similar circumstances).

In some implementations, the ODE computing system 300 can determine a prioritization of at least one capability based at least in part on the level of addressability 320 of the operational domain and output data indicative of the prioritization of the at least one capability. For example, the ODE computing system 300, as described herein, can determine a first level of addressability for the first operational domain 500 based at least in part on a first capability of the autonomous vehicle (e.g., the ability to operate in heavy snow) and a second level of addressability for the first operational domain 500 based at least in part on a second capability of the autonomous vehicle (e.g., the ability to perform an unprotected left turn). The ODE computing system 300 can determine a prioritization of the first capability of the autonomous vehicle 105 and the second capability of the autonomous vehicle 105 based at least in part on the first level of addressability and the second level of addressability. The capability that leads to a higher level of addressability (e.g., across one or more operational domain(s)) may be prioritized for technology development. For example, in the event that it is determined that adding the second capability (e.g., to perform an unprotected left turn) to an autonomous vehicle would lead to a higher level of addressability, the ODE computing system 300 can determine that the second capability should be prioritized over the first capability for technology development efforts. The ODE computing system 300 can output data indicative of the prioritization of the first capability of the autonomous vehicle 105 and the second capability of the autonomous vehicle 105 to another computing system, for display via a user interface on a display device, to a memory for storage, etc. The outputted data can indicate, for example, that the development of the second capability of the autonomous vehicle (e.g., the unprotected left turn capability) should be prioritized.

In some implementations, the ODE computing system 300 can be configured to rank a plurality of operational domains. For instance, the ODE computing system 300 can identify a first operational domain 500 and a second operational domain 600 as operational domains of interest. As described herein, the ODE computing system 300 determine a first level of addressability for the first operational domain 500 (e.g., City A) and a second level of addressability for the second operational domain 600 (e.g., City B). The ODE computing system 300 can determine a ranking of at least a first operational domain 500 and a second operational domain 600 based at least in part on a first level of addressability and a second level of addressability. In some implementations, the priority of the capability can be stored in the data structure 400A-C associated with the capabilities 405A-C (as shown in FIG. 4A-C).

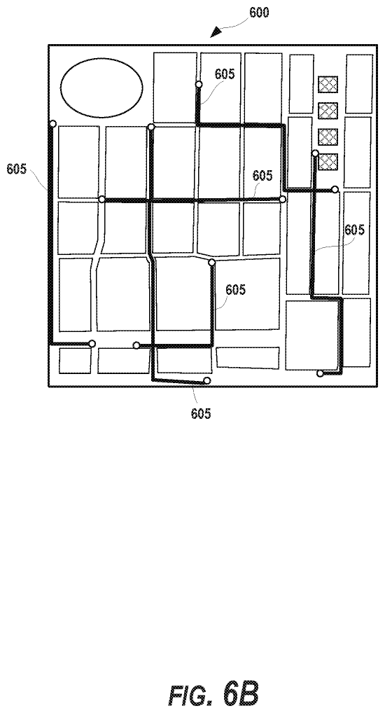

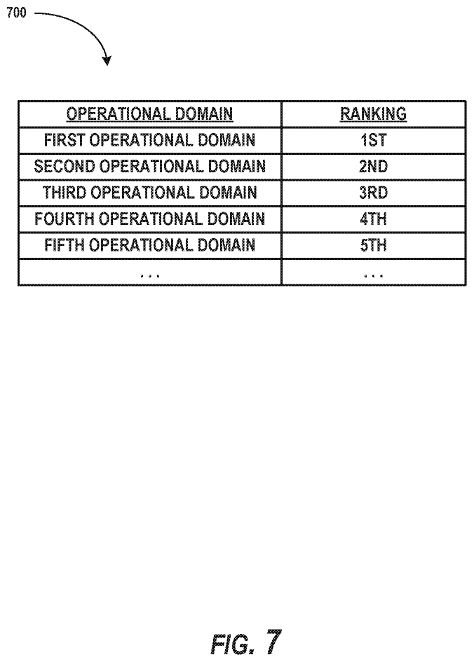

The ODE computing system 300 can output data indicative of the ranking of at least the first operational domain 500 and the second operational domain 600. For example, FIG. 7 depicts an example data 700 indicative of a ranking of operational domains according to example embodiments of the present disclosure. The data 700 can indicate that the first operational domain 500 ranks higher that the second operational domain 600 (and/or other operational domains) in the event that the first level of addressability of the first operational domain 500 is higher than the second level of addressability of the second operational domain 600 (and/or the level(s) of addressability of the other operational domain(s)) given one or more capabilities 405A-C. The ODE computing system 300 can output the data 700 to another computing system, for display via a user interface on a display device, to a memory for storage, etc. This can allow for the prioritization of various operational domains based at least in part on their levels of addressability of autonomous vehicle operations.

In some implementations, the ODE computing system 300 can be configured to communicate a mapping instruction associated with an operational domain. For example, the ODE computing system 300 can determine that a first operational domain 500 (e.g., City A) has a high level of addressability. The ODE computing system 300 can determine whether autonomous vehicle map data (e.g., map data for vehicle autonomy system operations) exists for the first operational domain 500. The ODE computing system 300 can determine that the autonomous vehicle map data does not exist or is insufficient for autonomous vehicle operation in the first operational domain 500. The ODE computing system 300 can generate data indicative of a mapping instruction for at least a portion of the first operational domain 500. The mapping instruction can include a command, request, inquiry, and/or other type of communication for map data associated with the first operational domain 500 to be acquired (e.g., via vehicle(s) with sensors, via a map database, etc.). The ODE computing system 300 can output data indicative of the mapping instruction for at least the portion of the first operational domain 500. For example, the ODE computing system 300 can communicate (e.g., to another computing system) the mapping instruction indicating that further mapping of the first operational domain 500 is needed, requested, recommended, etc.

In some implementations, the ODE computing system 300 can be configured to communicate a geo-fencing instruction for an operational domain. For instance, the ODE computing system 300 can determine one or more boundaries of an operational domain based at least in part on a level of addressability 320. The ODE computing system 300 can output data indicative of the one or more boundaries of the operational domain (e.g., to another computing system, to a memory for storage, for display via a user interface of a display device, etc.). By way of example, as described herein, the ODE computing system 300 can identify one or more sub-regions 510A-B of a first operational domain 500. The ODE computing system 300 can determine that a first sub-region 510A (e.g., Neighborhood X) may have a higher level of addressability than other sub-regions of the first operational domain 500. The ODE computing system 300 can determine one or more boundaries 525 of the first sub-region 510A (shown in FIG. 5D), which can define boundaries around the first sub-region 510A (e.g., Neighborhood X) within which an autonomous vehicle should operate within the first operational domain 500. The ODE computing system 300 can output data indicative of the one or more boundaries 525 of the first operational domain 500, which can be utilized to generate a geo-fence around the first sub-region 510A for the autonomous vehicle 105 (e.g., to prevent the autonomous vehicle from operating outside the first sub-region 510A).

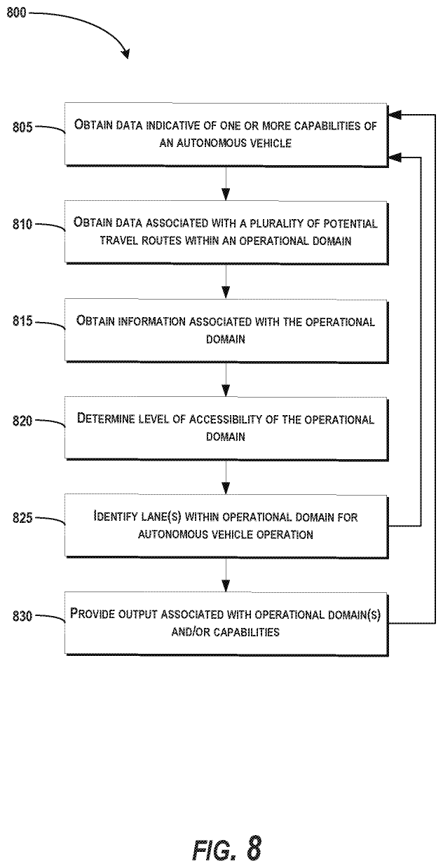

FIG. 8 depicts a flow diagram of an example method 800 for determining autonomous vehicle operational domains according to example embodiments of the present disclosure. One or more portion(s) of the method 800 can be implemented by a computing system that includes one or more computing devices such as, for example, the computing systems described with reference to the other figures (e.g., an operations computing system 200, an ODE computing system 300, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1-3 and/or 9), for example, to determine operational domains for autonomous vehicles. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for example illustrated purposes and is not meant to be limiting. One or more portions of method 800 can be performed additionally, or alternatively, by other systems.

At (805), the method 800 can include obtaining data indicative of one or more capabilities of an autonomous vehicle. For instance, a computing system (e.g., the ODE computing system 300) can obtain data indicative of one or more capabilities of an autonomous vehicle. The one or more capabilities of the autonomous vehicle can be indicative of at least one of an ability of the autonomous vehicle to operate in a weather condition, a vehicle operating condition, or a vehicle maneuverability, as described herein. The capabilities can be ones that are currently under development for an autonomous vehicle and may not yet be implemented in the autonomous vehicle(s) operating (or to be operating) in an operational domain.

At (810), the method 800 can include obtaining data associated with a plurality of potential travel routes within an operational domain. For instance, the computing system (e.g., the ODE computing system 300) can identify one or a plurality of operational domains of an autonomous vehicle. An operational domain(s) can include a geographic area. This may be an area in which autonomous vehicle(s) of a service entity are currently operating or may potentially be operating in the future. The computing system can obtain data associated with a plurality of potential travel routes within an operational domain of the autonomous vehicle. Each of the plurality of potential travel routes can start and end within the geographic area. As described herein, the plurality of potential travel routes can be based at least in part on a plurality of travel routes that are traversable by a non-autonomous vehicle. Additionally, or alternatively, as described herein, the computing system can determine the plurality of potential travel routes within an operational domain of the autonomous vehicle based at least in part on at least one of historic travel route data, simulated travel route data, or predicted travel route data.

At (815), the method 800 can include obtaining information associated with an operational domain. For instance, the computing system (e.g., the ODE computing system 300) can obtain information associated with the operational domain. The information can be indicative of at least one of weather associated with the operational domain, a regulation or policy associated with the operational domain, a lighting condition associated with the operational domain, or object data associated with the operational domain. Such data can be obtained for one or a plurality of operational domains.

At (820), the method 800 can include determining a level of addressability of the operational domain. For instance, the computing system (e.g., the ODE computing system 300) can determine a level of addressability of an operational domain based at least in part on the one or more capabilities of the autonomous vehicle and the plurality of potential travel routes within the operational domain of the autonomous vehicle. As described, herein the computing system can determine a number of the potential travel routes that are traversable by the autonomous vehicle based at least in part on the one or more capabilities of the autonomous vehicle. For example, as described herein, the computing system can filter the number of the potential travel routes within an operational domain based at least in part on a capability of the autonomous vehicle to determine whether an autonomous vehicle would be able to traverse a respective potential travel route (e.g., by leveraging an autonomous vehicle computing engine 325). As described herein, the level of addressability of the operational domain can be based at least in part on at least one of: the number of the potential travel routes that are traversable by the autonomous vehicle, a travel distance associated with the number of the potential travel routes that are traversable by the autonomous vehicle, a predicted number of service requests associated with the potential travel routes that are traversable by the autonomous vehicle, a predicted service time associated with the potential travel routes that are traversable by the autonomous vehicle, or a predicted level of revenue associated with the potential travel routes that are traversable by the autonomous vehicle. In some implementations, the level of addressability can be based at least in part on the computational (or power) resource utilization of an autonomous vehicle. Additionally, or alternatively, the computing system can determine the level of addressability of the operational domain based at least in part on the information associated with the operational domain (e.g., weather associated with the operational domain, a regulation or policy associated with the operational domain, a lighting condition associated with the operational domain, object data associated with the operational domain, etc.).

In some implementations, the computing system can identify a plurality of sub-regions of the operational domain and determine a respective level of addressability for each of the sub-regions of the operational domain. For instance, the computing system can identify a first sub-region, second sub-region, a third sub-region, etc. within an operational domain. The computing system can determine a level of addressability associated with each of these sub-regions to determine which of the sub-regions may potentially lead to a high autonomous vehicle usage rate.

At (825), the method 800 can include identifying one or more lane(s) within an operational domain for autonomous vehicle operation. For instance, as described herein, the computing system (e.g., the ODE computing system 300) can determine one or more lanes within the plurality of potential travel routes based at least in part on at least one of: the one or more capabilities of the autonomous vehicle, a number of projected service requests, a regulation or policy, or an estimated travel time. The computing system can identify which travel ways and/or lanes within an operational domain may be most efficient for the autonomous vehicle (e.g., lead to the most efficient usage of the vehicle's resources, less vehicle travel time, etc.).

At (830), the method 800 can include providing an output associated with operational domain(s) and/or capabilities. For instance, the computing system (e.g., the ODE computing system 300) can provide an output associated with an operational domain (and/or a plurality of operational domains) based at least in part on the level of addressability associated with the respective operational domain. This can include, for example, outputting data indicative of the level of addressability of the operational domain (e.g., to another computing system, for display via a user interface on a display device, into a memory, etc.). Additionally, or alternatively, the computing system can generate data indicative of a mapping instruction for at least a portion of the operational domain. The computing system can output data indicative of the mapping instruction for at least the portion of the operational domain. Additionally, or alternatively, the computing system can determine one or more boundaries of an operational domain based at least in part on the associated level of addressability of that operational domain. The computing system can output data indicative of the one or more boundaries of the operational domain (e.g., as a geo-fencing instruction).

The computing system can be configured to iterate its analysis across multiple vehicle capabilities and/or operational domains. For example, after completing one or more of operations 805 to 830 for a first capability and/or a first operational domain, the computing system can loop back to (805) or (810) and repeat the method 800 for a second capability and/or a second operational domain. As described herein, the computing system can determine a prioritization of a first capability of the autonomous vehicle and a second capability of the autonomous vehicle and output data indicative of a prioritization of the first capability of the autonomous vehicle and the second capability of the autonomous vehicle. Additionally, or alternatively, as described herein, the computing system can determine a ranking of at least a first operational domain and a second operational domain based at least in part on a first level of addressability associated with the first operational domain and a second level of addressability associated with a second operational domain associated with the second level of addressability. The computing system can output data indicative of the ranking of at least the first operational domain and the second operational domain.

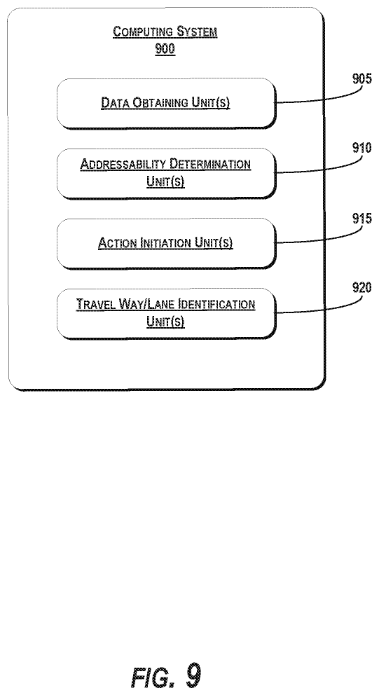

Various means can be configured to perform the methods and processes described herein. For example, FIG. 9 depicts a diagram of an example a computing system 900 that includes various means according to example embodiments of the present disclosure. The computing system 900 can be and/or otherwise include, for example, the ODE computing system 300. The computing system 900 can include data obtaining unit(s) 905, addressability determination unit(s) 910, action initiation unit(s) 915, travel way/lane identification unit(s) 920, and/or other means for performing the operations and functions described herein. In some implementations, one or more of the units may be implemented separately. In some implementations, one or more units may be a part of or included in one or more other units.

These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. The methods (e.g., 800) and/or other operations described herein can be implemented as such algorithm(s). For instance, the means (e.g., the data obtaining unit(s) 905) can be configured to obtain data indicative of one or more capabilities of an autonomous vehicle (e.g., via an accessible memory). The means (e.g., the data obtaining unit(s) 905) can be configured to obtain data associated with a plurality of potential travel routes within an operational domain of the autonomous vehicle (e.g., via an accessible memory). In some implementations, the means (e.g., the data obtaining unit(s) 905) can be configured to determine the plurality of potential travel routes within the operational domain based at least in part on (at least one of): historic travel route data, simulated travel route data, or predicted travel route data. In some implementations, the means (e.g., the data obtaining unit(s) 905) can be configured to obtain information (e.g., weather information, regulation/policy information, lighting information, object data, etc.) associated with the operational domain (e.g., via an accessible memory).

The means (e.g., the addressability determination unit(s) 910) can be configured to determine a level of addressability of the operational domain based at least in part on the one or more capabilities of the autonomous vehicle, the plurality of potential travel routes within the operational domain of the autonomous vehicle, and/or the other information associated with the operational domain. For example, the means (e.g., the addressability determination unit(s) 910) can be configured to filter the potential travel routes based at least in part on the one or more capabilities and/or the information associated with the operational domain to determine which of the potential travel routes are traversable by an autonomous vehicle (e.g., the level of addressability indicating the amount of autonomous vehicle traversable routes). In some implementations, the means (e.g., the addressability determination unit(s) 910) can be configured to identify a plurality of sub-regions of the operational domain and determine a respective level of addressability for each of the sub-regions of the operational domain, as described herein. The means (e.g., the addressability determination unit(s) 910) can be configured to determine the level of addressability based at least in part on a variety of factors, as described herein.

The means (e.g., the travel way/lane identification unit(s) 920) can be configured to determine one or more lanes within the plurality of potential travel routes for an autonomous vehicle based at least in part on at least one of: the one or more capabilities of the autonomous vehicle, a number of projected service requests, a regulation or policy, or an estimated travel time, as described herein.

The means (e.g., the action initiation unit(s) 915) can be configured to initiate an action based at least in part on a level of addressability of an operational domain. For example, the means (e.g., the action initiation unit(s) 915) can be configured to provide an output, as described herein. The means (e.g., the action initiation unit(s) 915) can output data indicative of the level of addressability of the operational domain (e.g., to a memory, to another computing system, for display via a display device, etc.). Additionally, or alternatively, the means (e.g., the action initiation unit(s) 915) can be configured to generate data indicative of a mapping instruction for at least a portion of the operational domain and output data indicative of the mapping instruction for at least the portion of the operational domain (e.g., to a memory, to another computing system, for display on a display device, etc.). Additionally, or alternatively, the means (e.g., the action initiation unit(s) 915) can be configured to determine one or more boundaries of the operational domain based at least in part on the level of addressability and output data indicative of the one or more boundaries of the operational domain (e.g., to a memory, to another computing system, for display on a display device, etc.). Additionally, or alternatively, the means (e.g., the action initiation unit(s) 915) can be configured to generate a prioritization of one or more capabilities and output data indicative of such prioritization (e.g., to a memory, to another computing system, for display on a display device, etc.). Additionally, or alternatively, the means (e.g., the action initiation unit(s) 915) can be configured to generate a ranking of operational domains and output data indicative of such a ranking (e.g., to a memory, to another computing system, for display on a display device, etc.).

These described functions of the means are provided as examples and are not meant to be limiting. The means can be configured for performing any of the operations and functions described herein.

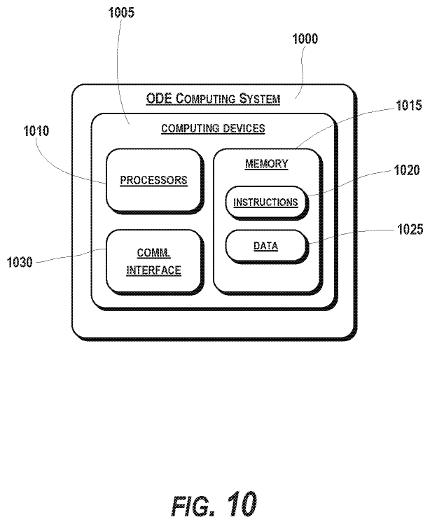

FIG. 10 depicts an example computing system 1000 according to example embodiments of the present disclosure. The computing system 1000 illustrated in FIG. 10 is provided as an example only. The components, systems, connections, and/or other aspects illustrated in FIG. 10 are optional and are provided as examples of what is possible, but not required, to implement the present disclosure. The computing system 1000 can represent/correspond to the vehicle computing system, operations computing system, ODE computing system, and/or other computing systems, devices, units, etc. described herein. The computing system 1000 can be communicatively coupled with a remote computing system over one or more network(s).

The computing device(s) 1005 of the computing system 1000 can include processor(s) 1010 and a memory 1015. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1015 can include one or more non-transitory computer-readable storage media, such as RAM, ROM, EEPROM, EPROM, one or more memory devices, flash memory devices, data registrar, etc., and combinations thereof

The memory 1015 can store information that can be accessed by the one or more processors 1015. For instance, the memory 1015 (e.g., one or more non-transitory computer-readable storage mediums, memory devices) can include computer-readable instructions 1020 that can be executed by the one or more processors 1015. The instructions 1020 can be software written in any suitable programming language or can be implemented in hardware. Additionally, or alternatively, the instructions 1020 can be executed in logically and/or virtually separate threads on processor(s) 1010.

For example, the memory 1015 can store instructions 1020 that when executed by the one or more processors 1010 cause the one or more processors 1010 (the computing system 1000) to perform operations such as any of the operations and functions of the vehicle computing system 100 (or for which it is configured), one or more of the operations and functions of the vehicle provider computing systems (or for which it is configured), one or more of the operations and functions of the operations computing systems described herein (or for which it is configured), one or more of the operations and functions of the ODE computing system (or for which it is configured) one or more operations and functions for evaluating and determining operational domain(s) of an autonomous vehicle, one or more portions of method 800, and/or one or more of the other operations and functions of the computing systems described herein.

The memory 1015 can store data 1025 that can be obtained (e.g., acquired, received, retrieved, accessed, created, stored, etc.). The data 1025 can include, for instance, any of the data/information described herein such as, for example, data indicative of one or more capabilities of an autonomous vehicle, data indicative of operational domain(s), data indicative of potential travel routes, information associated with operational domain(s), data indicative of sub-region(s), data indicative of levels of addressability, data indicative of boundaries, data indicative of mapping instructions, data indicative of prioritizations, data indicative of rankings, outputs, and/or other data/information. In some implementations, the computing device(s) 1005 can obtain data from one or more memories that are remote from the computing system 1000.

The computing device(s) 1005 can also include a communication interface 1030 used to communicate with one or more other system(s) of the computing system 1000 and/or a remote computing device that is remote from the computing system 1000. The communication interface 1030 can include any circuits, components, software, etc. for communicating via one or more networks. The communication interface 1030 can include, for example, one or more of a communications controller, receiver, transceiver, transmitter, port, conductors, software and/or hardware for communicating data.

The network(s) utilized by the computing system 1000 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) can be accomplished, for instance, via a communication interface using any type of protocol, protection scheme, encoding, format, packaging, etc.

Computing tasks, operations, and functions discussed herein as being performed at one computing system herein can instead be performed by another computing system, and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for determining autonomous vehicle operational domains comprising:
obtaining, by a computing system comprising one or more computing devices, data indicative of one or more capabilities of an autonomous vehicle;
obtaining, by the computing system, data associated with a plurality of potential travel routes within an operational domain of the autonomous vehicle;
determining, by the computing system, a level of addressability of the operational domain based at least in part on the one or more capabilities of the autonomous vehicle and the plurality of potential travel routes within the operational domain, wherein the level of addressability represents an ability of the autonomous vehicle to provide a service within the operational domain; and
providing, by the computing system, an output associated with the operational domain based at least in part on the level of addressability associated with the operational domain.

2. The computer-implemented method of claim 1, wherein the one or more capabilities of the autonomous vehicle are indicative of at least one of an ability of the autonomous vehicle to operate in a weather condition, a vehicle operating condition, or a vehicle maneuverability.

3. The computer-implemented method of claim 1, wherein the operational domain comprises a geographic area, and wherein each of the plurality of potential travel routes start and end within the geographic area.

4. The computer-implemented method of claim 1, wherein the plurality of potential travel routes is based at least in part on a plurality of travel routes that are traversable by a non-autonomous vehicle.

5. The computer-implemented method of claim 1, wherein obtaining the data associated with the plurality of potential travel routes comprises:
determining, by the computing system, the plurality of potential travel routes within the operational domain of the autonomous vehicle based at least in part on at least one of historic travel route data, simulated travel route data, or predicted travel route data.

6. The computer-implemented method of claim 1, wherein determining, by the computing system, the level of addressability associated with the operational domain comprises:
determining, by the computing system, a number of the potential travel routes that are traversable by the autonomous vehicle based at least in part on the one or more capabilities of the autonomous vehicle.

7. The computer-implemented method of claim 6, wherein the level of addressability of the operational domain is based at least in part on at least one of the number of the potential travel routes that are traversable by the autonomous vehicle, a travel distance associated with the number of the potential travel routes that are traversable by the autonomous vehicle, a predicted number of service requests associated with the potential travel routes that are traversable by the autonomous vehicle, a predicted service time associated with the potential travel routes that are traversable by the autonomous vehicle, or a predicted level of revenue associated with the potential travel routes that are traversable by the autonomous vehicle.

8. The computer-implemented method of claim 1, further comprising:
obtaining, by the computing system, information associated with the operational domain, wherein the information is indicative of at least one of weather associated with the operational domain, a regulation or policy associated with the operational domain, a lighting condition associated with the operational domain, or object data associated with the operational domain.

9. The computer-implemented method of claim 8, wherein determining, by the computing system, the level of addressability of the operational domain comprises:
determining, by the computing system, the level of addressability of the operational domain based at least in part on the information associated with the operational domain.

10. The computer-implemented method of claim 1, wherein determining, by the computing system, the level of addressability of the operational domain comprises:
identifying, by the computing system, a plurality of sub-regions of the operational domain; and
determining, by the computing system, a respective level of addressability for each of the sub-regions of the operational domain.

11. The computer-implemented method of claim 10, further comprising:
determining, by the computing system, one or more lanes within the plurality of potential travel routes based at least in part on at least one of: the one or more capabilities of the autonomous vehicle, a number of projected service requests, a regulation or policy, or an estimated travel time.

12. The computer-implemented method of claim 1, wherein providing, by the computing system, the output associated with the operational domain based at least in part on the level of addressability associated with the operational domain comprises:
outputting, by the computing system, data indicative of the level of addressability of the operational domain.

13. The computer-implemented method of claim 1, wherein providing, by the computing system, the output associated with the operational domain based at least in part on the level of addressability associated with the operational domain comprises:
generating, by the computing system, data indicative of a mapping instruction for at least a portion of the operational domain; and
outputting, by the computing system, data indicative of the mapping instruction for at least the portion of the operational domain.

14. The computer-implemented method of claim 1, wherein providing, by the computing system, the output associated with the operational domain based at least in part on the level of addressability associated with the operational domain comprises:
determining, by the computing system, one or more boundaries of the operational domain based at least in part on the level of addressability; and
outputting, by the computing system, data indicative of the one or more boundaries of the operational domain.

15. The computer-implemented method of claim 1, wherein the operational domain is a first operational domain, wherein the level of addressability is a first level of addressability for the first operational domain, and wherein the method further comprises:
obtaining, by the computing system, data associated with a plurality of travel routes within a second operational domain;
determining, by the computing system, a second level of addressability of the second operational domain based at least in part on the one or more capabilities of the autonomous vehicle and the plurality of potential travel routes within the second operational domain; and
determining, by the computing system, a ranking of at least the first operational domain and the second operational domain based at least in part on the first level of addressability and the second level of addressability,
wherein providing the output comprises outputting, by the computing system, data indicative of the ranking of at least the first operational domain and the second operational domain.

16. The computer-implemented method of claim 1, wherein the one or more capabilities comprise a first capability of the autonomous vehicle and a second capability of the autonomous vehicle, and wherein determining the level of addressability for the operational domain comprises:
determining a first level of addressability for the first operational domain based at least in part on the first capability of the autonomous vehicle;
determining a second level of addressability for the first operational domain based at least in part on the second capability of the autonomous vehicle; and
determining a prioritization of the first capability of the autonomous vehicle and the second capability of the autonomous vehicle based at least in part on the first level of addressability and the second level of addressability,
wherein providing the output comprises outputting data indicative of the prioritization of the first capability of the autonomous vehicle and the second capability of the autonomous vehicle.

17. A computing system comprising:
one or more processors; and
one or more tangible, non-transitory, computer readable media that collectively store instructions that when executed by the one or more processors cause the computing system to perform operations comprising:
obtaining data indicative of one or more capabilities of an autonomous vehicle;
identifying one or more operational domains;
for each of the one or more operational domains, obtaining data associated with a plurality of potential travel routes within the respective operational domain;
determining, for each respective operational domain, a respective level of addressability based at least in part on the one or more capabilities of the autonomous vehicle and the plurality of potential travel routes within the respective operational domain, wherein the level of addressability represents an ability of the autonomous vehicle to provide a service within the operational domain; and
providing an output based at least in part on one or more of the respective levels of addressability associated with the one or more operational domains.

18. The computing system of claim 17, wherein the one or more operational domains comprise a first operational domain associated and a second operational domain, wherein determining, for each respective operational domain, the level of addressability comprises:
determining a first level of addressability for the first operational domain based at least in part on the one or more capabilities of the autonomous vehicle and a first plurality of potential travel routes within the first operational domain; and
determining a second level of addressability for the second operational domain based at least in part on the one or more capabilities of the autonomous vehicle and a second plurality of potential travel routes within the second operational domain.

19. The computing system of claim 17, wherein the one or more capabilities comprise a first capability of the autonomous vehicle and a second capability of the autonomous vehicle, wherein the one or more operational domains comprise a first operational domain, and wherein determining, for each respective operational domain, the level of addressability comprises:
determining a first level of addressability for the first operational domain based at least in part on the first capability of the autonomous vehicle; and
determining a second level of addressability for the first operational domain based at least in part on the second capability of the autonomous vehicle.

20. One or more tangible, non-transitory, computer-readable media that collectively store instructions that, when executed by one or more processors, cause the one or more processors to perform operations, the operations comprising:
obtaining data indicative of a capability of an autonomous vehicle;
identifying a plurality of operational domains;
determining, for each of the operational domains, a respective level of addressability associated with the respective operational domain based at least in part on the capability of the autonomous vehicle, wherein the level of addressability represents an ability of the autonomous vehicle to provide a service within the operational domain; and
providing an output associated with the plurality of operational domains based at least in part on the levels of addressability associated with the plurality of operational domains.
